(19) United States
(12) Patent Application Publication
(10) Pub. No.: US 2025/0030471 A1
(43) Pub. Date: Jan. 23, 2025

(54) METHOD AND DEVICE FOR RECEIVING AND TRANSMITTING INFORMATION

(71) Applicant: SAMSUNG ELECTRONICS CO., LTD., Suwon-si (KR)

(72) Inventors: Zhe CHEN, Beijing (CN); Jingxing FU, Beijing (CN); Sa ZHANG, Beijing (CN); Feifei SUN, Beijing (CN)

(21) Appl. No.: 18/778,832

(22) Filed: Jul. 19, 2024

(30) Foreign Application Priority Data
Jul. 21, 2023 (CN) 202310908279.2
Nov. 1, 2023 (CN) 202311446798.8
Dec. 27, 2023 (CN) 202311825353.0

(51) Int. Cl. H04B 7/06; H04W 72/231

(52) U.S. Cl. CPC H04B 7/0626; H04B 7/0632; H04W 72/231

(57) ABSTRACT

The disclosure relates to a 5G or 6G communication system for supporting a higher data transmission rate. The disclosure provides a method performed by a user equipment (UE) in a wireless communication system. The method includes: receiving, from a base station, channel state information (CSI) report configuration information including a list of sub-configurations; and transmitting, to the base station, a first CSI report for at least one sub-configuration associated with the list of sub-configurations.

### CROSS-REFERENCE TO RELATED APPLICATIONS

This application claims priority under 35 U.S.C. § 119 (a) to Chinese Patent Application No. 202310908279.2, which was filed in the Chinese Patent Office on Jul. 21, 2023, Chinese Patent Application No. 202311446798.8, which was filed in the Chinese Patent Office on Nov. 1, 2023, and Chinese Patent Application No. 202311825353.0, which was filed in the Chinese Patent Office on Dec. 27, 2023, the entire disclosures of which are incorporated herein by reference.

### BACKGROUND

### 1. Field

This application relates to the field of wireless communication technologies, and more specifically, to a method and a device for receiving and transmitting information.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also referred to as “beyond 4G networks” or “post-LTE systems”.

The 5G communication system is implemented at higher frequency bands (mmWave), such as the 60 GHz frequency band, for achieving higher data rates. To reduce radio wave propagation losses and increase transmission distances, techniques such as beamforming, massive multiple-input multiple-output (MIMO), full-dimensional MIMO (FD-MIMO), antenna arrays, analog beamforming, and massive antenna technology are being discussed in the context of 5G communication systems.

Moreover, in 5G communication systems, developments are underway to improve system networks based on advanced small cells, cloud radio access networks (RAN), ultra-dense networks, device-to-device (D2D) communication, wireless backhaul, mobile networks, cooperative communication, coordinated multi-point (COMP), and receiver interference cancellation.

In 5G systems, advanced coding modulation (ACM) schemes such as hybrid FSK and QAM (FQAM) and sliding window superposition coding (SWSC), as well as advanced access techniques such as filter bank multi-carrier (FBMC), non-orthogonal multiple access (NOMA), and sparse code multiple access (SCMA) have been developed.

The transmission from base stations to user equipment (UE) is known as the downlink, while the transmission from UE to base stations is referred to as the uplink.

### SUMMARY

An aspect of the disclosure provides a method performed by a user equipment (UE) in a wireless communication system, the method comprising: receiving, from a base station, channel state information (CSI) report configuration information including a list of sub-configurations; and transmitting, to the base station, a first CSI report for at least one sub-configuration associated with the list of sub-configurations.

An aspect of the disclosure provides a method performed by a base station in a wireless communication system, the method comprising: transmitting, to a user equipment (UE), channel state information (CSI) report configuration information including a list of sub-configurations; and receiving, from the UE, a first CSI report for at least one sub-configuration associated with the list of sub-configurations.

An aspect of the disclosure provides a user equipment (UE) in a wireless communication system, the UE comprising: a transceiver; and at least one processor coupled to the transceiver and configured to: receive, from a base station, channel state information (CSI) report configuration information including a list of sub-configurations; and transmit, to the base station, a first CSI report for at least one sub-configuration associated with the list of sub-configurations.

An aspect of the disclosure provides a base station in a wireless communication system, the base station comprising: a transceiver; and at least one processor coupled to the transceiver and configured to: transmit, to a user equipment (UE), channel state information (CSI) report configuration information including a list of sub-configurations; and receive, from the UE, a first CSI report for at least one sub-configuration associated with the list of sub-configurations.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of the disclosure will be more apparent from the following detailed descriptions with reference to the accompanying drawings.

FIG. 1 illustrates a general structure of an example wireless communication network according to various embodiments of the disclosure;

FIG. 2A and FIG. 2B respectively illustrate a transmission path and a reception path in a wireless communication network according to various embodiments of the disclosure;

FIG. 3A and FIG. 3B respectively illustrate structures of a user equipment (UE) and a base station in a wireless communication network according to various embodiments of the disclosure;

FIG. 4 illustrates a method performed by a UE according to various embodiments of the disclosure;

FIG. 5 illustrates a method performed by a base station according to various embodiments of the disclosure;

FIG. 6 illustrates a structure of a UE according to various embodiments of the disclosure; and

FIG. 7 illustrates a structure of a base station according to various embodiments of the disclosure.

### DETAILED DESCRIPTION

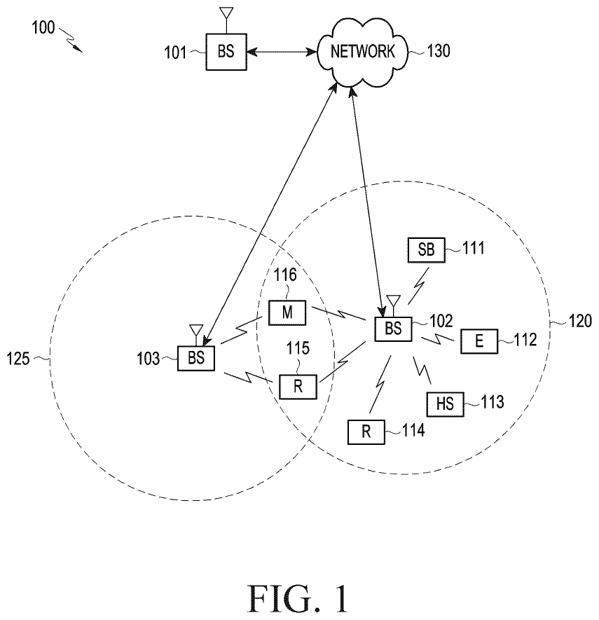

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. It should be noted that in the drawings, the same or similar elements are preferably denoted by the same or similar reference numerals. In addition, detailed descriptions of known functions or configurations that may make the subject matter of the disclosure unclear will be omitted.

When describing the embodiments of the disclosure, descriptions related to technical content that is well known in the field and not directly related to the disclosure will be omitted. Such omission of unnecessary descriptions is to prevent obscuring the main idea of the disclosure and to convey the main idea more clearly.

For the same reason, in the drawings, certain elements may be enlarged, omitted, or schematically represented. Additionally, the size of each element does not necessarily reflect its actual size. In the drawings, the same or corresponding elements have the same reference numerals.

By referring to the detailed description of the embodiments provided below in conjunction with the accompanying drawings, the advantages and features of the disclosure, as well as the manner of implementing them, will become apparent. However, the disclosure is not limited to the embodiments described below, but can be implemented in various different forms. The following embodiments are provided solely for the purpose of fully disclosing the disclosure and informing those skilled in the art about the scope of the disclosure, and the disclosure is only limited by the claims appended hereto. Throughout the specification, the same or similar reference numerals indicate the same or similar elements.

FIG. 1 illustrates an example wireless communication network 100 according to various embodiments of the present disclosure. The embodiment of the wireless communication network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point (AP)” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

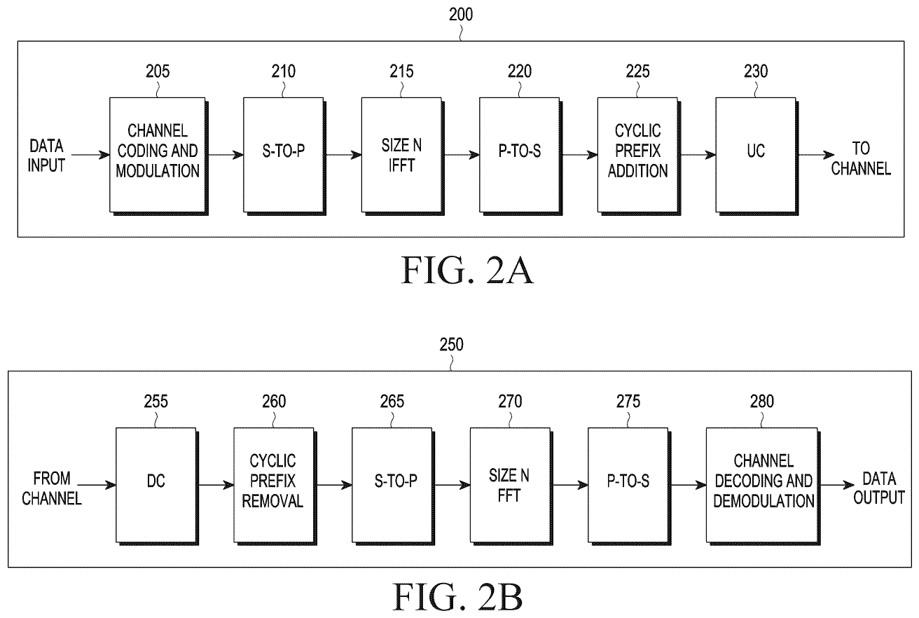

FIG. 2A and FIG. 2B illustrate a transmission path 200 and a reception path 250 in a wireless communication network according to various embodiments of the present disclosure, respectively. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

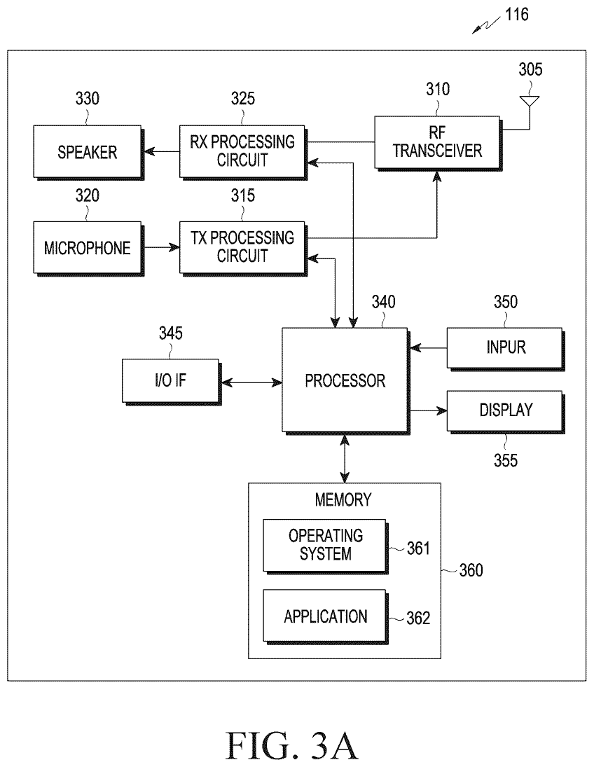

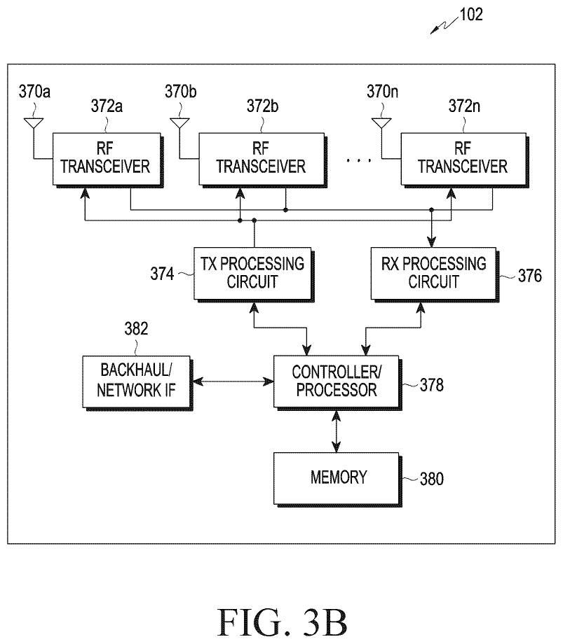

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

At present, in a wireless communication system, a user equipment (UE) can only obtain a power parameters and/or an airspace parameter change of a network device side in a semi-static way, which cannot meet flexible adjustment requirements of a base station side.

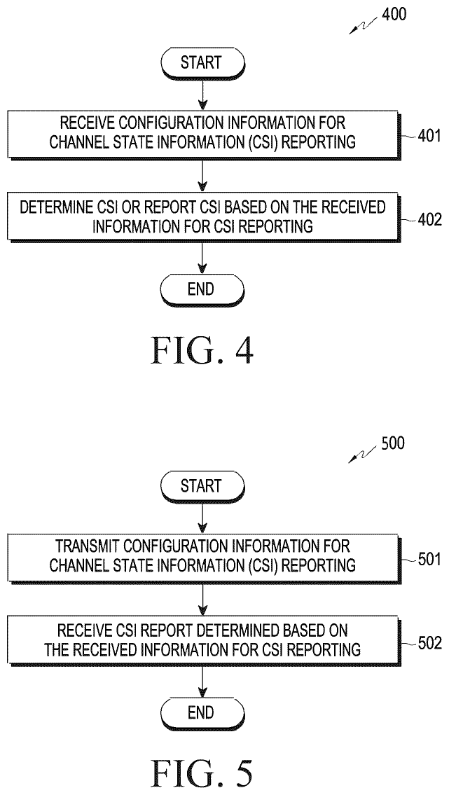

Hereinafter, various embodiments of the application will be described in detail with reference to the drawings. FIG. 4 illustrates a method 400 performed by a UE according to various embodiments of the disclosure. The method 400 includes: at 401, the UE receives configuration information for CSI report; and at 402, the UE determines CSI or reports CSI based on the received configuration information for CSI report. Optionally, a CSI report for carrying CSI may correspond to/be associated with one CSI computation delay parameter. The CSI computation delay parameter will be described in detail in combination with the various embodiments herein. Herein, the term “CSI report configuration information” can be used interchangeably with the terms “configuration information for CSI report” and “information for configuring CSI report”.

### Embodiment 1

The UE may receive a downlink control information (DCI). Optionally, the DCI triggers aperiodic report. Optionally, the DCI (or CSI request field in the DCI) may trigger one or more CSI reports (on a physical uplink shared channel (PUSCH)). For example, the one or more CSI reports are carried by the PUSCH. Optionally, the one or more CSI reports include (one) first CSI report.

Optionally, the one or more CSI reports include/correspond to first CSI report. For example, the first CSI report represents an n-th (triggered) report among one or more report(s).

Optionally, the UE determines/feedbacks/reports the first CSI report (or the UE provides a (valid) CSI report for the first CSI report). Optionally, when at least one of the following conditions is met, the UE determines/feedbacks/reports the first CSI report (or the UE provides a (valid) CSI report for the first CSI report):
the time unit to carry the one or more CSI report(s) starts no earlier than the first time unit. For example, the unit of the time unit may be slot or symbol. For example, the time unit to carry the one or more CSI report(s) may be the first uplink symbol to carry the one or more CSI report(s). Optionally, the uplink symbol includes (or needs to consider) the effect of the timing advance. Descriptions of the first time unit (e.g., Z_{ref}) is given below.
the time unit to carry the first CSI report starts no earlier than at second time unit. For example, the unit of the time unit may be slot or symbol. For example, the time unit carrying the first CSI report may be the first uplink symbol to carry the first CSI report. Optionally, the uplink symbol includes (or needs to consider) the effect of the timing advance. Descriptions of the second time unit is given below.

Optionally, the first time unit (e.g., Z_{ref}) is determined based on the time unit at which a physical downlink control channel (PDCCH) corresponding to the DCI (for example, the DCI triggering the one or more CSI reports) is located and the CSI computation delay parameter(s) corresponding to one (or each) CSI report of the one or more CSI report(s). Optionally, the first time unit may be the uplink symbol (for example, the next uplink symbol) (first specific time) after the end of the last symbol of the PDCCH corresponding to the DCI (for example, the DCI triggering the one or more CSI report(s)). Optionally, the first specific time is determined based on the CSI computation delay parameter(s) corresponding to one (or each) CSI report of the one or more CSI report(s). For example, Z_{ref} is defined as the next uplink symbol, and the next uplink symbol with its CP starting T_{proc,CSI}=(Z)(2048+144)·κ2^{-μ}·T_{C}+T_{switch} after the end of the last symbol of the PDCCH triggering the CSI report(s). Here, for descriptions of the parameter μ, refer to descriptions of Table 1. T_{C} represents a basic time unit for NR. K represents the ratio between T_{S} and T_{C}. T_{S} represents a basic time unit for LTE. T_{switch} is a parameter used to represent an uplink switching time gap. For example, T_{switch} is equal to switching gap duration or 0. Z represents/is equal to a maximum value of the CSI computation delay parameter corresponding to each CSI report in an updated CSI report (of the one or more CSI report(s)). Optionally, the (one or more) updated CSI report of the one or more CSI reports are determined according to CSI processing criteria (e.g., rules related to a CSI processing unit (CPU)). For example, the terminal device may determine which CSI reports need to be updated and which CSI reports are not required to be updated based on a total number of CPUs (CSI processing units) and a number of occupied CPUs. Optionally, the updated reports are denoted as a report 0, a report 1, . . . , a report M−1, where the number of updated report(s) is M. Optionally, each report may correspond to one CSI computation delay parameter. For example, a CSI computation delay parameter corresponding to a report m is Z(m), where m=0, 1, . . . , M−1.

$$\\ Z = {max}_{m = 0 , 1 , … , M - 1} Z ( m ) .$$

Optionally, the second time unit (e.g., Z′_{ref}) is determined based on a time unit of measurement resource corresponding to the first CSI report and a CSI computation delay parameter corresponding to the first CSI report. Optionally, the measurement resource includes resource for channel measurement and/or resource for interference measurement. Optionally, the measurement resource may be aperiodic resource. Optionally, the measurement resource corresponding to the first CSI report may be the latest resource among measurement resources. For example, in a case in which there are a plurality of measurement resources corresponding to the first CSI report, the measurement resources corresponding to the first CSI report refer to latest measurement resources (in time domain) used for the first CSI report. For example, a time unit of the measurement resource corresponding to the first CSI report refers to the last symbol (in time) of the latest resource among the measurement resources used for the first CSI report. Optionally, the second time unit may be an uplink symbol (second specific time) after the last symbol of the latest resource among the measurement resources used for the first CSI report. Optionally, the second specific time is determined based on the CSI computation delay parameter corresponding to one (or each) CSI report of the one or more CSI report(s). For example, the first CSI report is used as an example, Z′_{ref} is defined as the next uplink symbol with its CP starting T′_{proc,CSI}=(Z′)(2048+144)·κ2^{-μ}·T_{C} after the end of the last symbol in time of the latest of: aperiodic CSI-RS resource for channel measurements, aperiodic CSI-IM used for interference measurements, and aperiodic NZP CSI-RS for interference measurement, when aperiodic CSI-RS is used for channel measurement for the first CSI report. Here, for descriptions of the parameter μ, refer to descriptions of Table 1. T_{C} represents a basic time unit for NR. κ represents the ratio between T_{S} and T_{C}. T_{S} represents a basic time unit for LTE. Z′ represents a maximum value of the CSI computation delay parameter corresponding to each CSI report in an updated CSI report (of the one or more CSI reports). Optionally, the (one or more) updated CSI report of the one or more CSI reports are determined according to CSI processing criteria (e.g., rules related to a CPU). For example, the terminal device may determine which CSI reports need to be updated and which CSI reports are not required to be updated based on a total number of CPUs (CSI processing units) and a number of occupied CPUs. Optionally, the updated reports are denoted as a report 0, a report 1, . . . , a report M−1, where the number of updated report(s) is M. Optionally, each report may correspond to one CSI computation delay parameter. For example, a CSI computation delay parameter corresponding to a reporting m is Z′(m), where m=0, 1, . . . , M−1·

$$\\ {Z}^{{}_{} ′} {max}_{m = 0 , 1 , … , M - 1} {Z}^{{}_{} ′} ( m ) .$$

Optionally, the UE may receive a DCI. Optionally, the DCI triggers aperiodic reporting. Optionally, the DCI (or the CSI request field in the DCI) may trigger one or more CSI reports (on a PUSCH).

Optionally, if (the start of) the time unit to carry the one or more CSI reports is earlier than the first time unit, the UE ignores the DCI (or scheduling DCI). For example, the DCI is the DCI that triggers the one or more CSI report(s). Optionally, the time unit to carry the one or more CSI report(s) includes (or needs to consider) the effect of the timing advance. Here, for the first time unit, refer to the above descriptions.

Optionally, if (the start of) the time unit to carry the first CSI report is earlier than the second time unit, the UE performs at least one of the following operations:
if no hybrid automatic repeat request-acknowledgement (HARQ-ACK) or transport block is multiplexed on the PUSCH and the number of the one or more CSI report(s) is 1, the UE ignores the DCI (or scheduling DCI);
Otherwise, the UE is not required to update the first CSI report.

Optionally, the time unit carrying the first CSI reports includes (or needs to consider) the effect of the timing advance. Here, for the second time unit, refer to the above descriptions.

Optionally, one of the one or more CSI reports (e.g., the first CSI report) may correspond to one or more first sub-configuration(s). The first CSI report is used as an example below to describe, when the one or more CSI reports include the first CSI report (corresponding to the one or more first sub-configuration(s)), how to determine the measurement resource and/or the CSI computation delay parameter corresponding to the CSI report (corresponding to one or more first sub-configuration(s)).

Optionally, the UE receives CSI report configuration information (for example, CSI-ReportConfig). Optionally, the CSI report configuration information is associated with/corresponds to/includes one or more first sub-configuration(s). Here, a sub-configuration may be referred to as sub-configuration information. Optionally, the first sub-configuration may be sub-configuration information for CSI report. Here, the CSI report configuration information may correspond to a CSI report, or the CSI report configuration information may refer to a CSI report. For example, the CSI report configuration information corresponds to/refers to the first CSI report.

Optionally, second sub-configuration(s) includes one of the one or more first sub-configuration(s). Optionally, the second sub-configuration is (for example, one, or any one, or each, or all) of a plurality of first sub-configuration(s). For example, when the CSI report configuration information corresponds to a periodic CSI report, the second sub-configuration is (for example, one, or any one, or each) of the one or more first sub-configuration(s). Optionally, when the CSI report configuration information corresponds to the periodic CSI report, each report instance of the periodic CSI report is for all sub-configuration(s) in the one or more first sub-configuration(s). For example, a number of the one or more first sub-configuration(s) may be L, where L>1 (or L≥1). For example, a number of the one or more first sub-configuration(s) may be L, where L>1 (or L≥1). For example, the second sub-configuration(s) are all sub-configuration(s) in a subset of the one or more first sub-configuration(s), and the number of the second sub-configuration(s) may be N, where N≤L and/or N≥1. Optionally, for the case that the CSI report is a periodic CSI report, N=L. For example, the CSI report includes CSI parameters corresponding to all the sub-configuration(s) in the one or more first sub-configuration(s). Optionally, that the CSI report configuration information corresponds to the periodic CSI report means that a report type parameter (reportConfigType) in the CSI report configuration information (for example, CSI-ReportConfig) is set to “periodic”.

Optionally, the second sub-configuration includes a subset of the one or more first sub-configuration(s). Optionally, the second sub-configuration is (for example, one, or any one, or each, or all) first sub-configuration in the subset of the one or more first sub-configuration(s). For example, when the CSI report configuration information corresponds to a semi-persistent CSI report or an aperiodic CSI report, the second sub-configuration may be (for example, one, or any one, or each, or all) first sub-configuration in the subset of the one or more first sub-configuration(s). For example, a number of the one or more first sub-configuration(s) may be 1, where L>1 (or L≥1). For example, the second sub-configuration(s) are all sub-configuration(s) in a subset of the one or more first sub-configuration(s) and the number of the second sub-configuration(s) may be N, where N≤L and/or N≥1. Optionally, this subset is indicated (or is provided) by a signalling triggering/activating/scheduling/indicating the CSI report corresponding to the CSI report configuration information. For example, the CSI report configuration information includes (or is configured with) L sub-configuration(s), and a signalling can trigger/activate/schedule/indicate the CSI report corresponding to the CSI report configuration information, and the signalling can indicate N sub-configuration(s) out of L sub-configuration(s) are used for the CSI report. For example, N≤L and/or N≥1. For example, the UE may generate/derive CSI parameters corresponding to N sub-configuration(s) among the L sub-configuration(s) and include them into the CSI report. For example, if the CSI report configuration information corresponds to a semi-persistent CSI report on a physical uplink control channel (PUCCH), and the CSI report configuration information includes (or is configured with) L sub-configuration(s), a media access control-control element (MAC-CE) signalling can trigger the CSI report corresponding to the CSI report configuration information (for example, the CSI report is carried by the PUCCH), and the MAC-CE signalling can include the indication information for indicating N sub-configuration(s) from the L sub-configuration(s) for the CSI report. For example, if the CSI report configuration information corresponds to a semi-persistent CSI report on a physical uplink shared channel (PUSCH), and the CSI report configuration information includes (or is configured with) L sub-configuration(s), downlink control information (DCI) (or a DCI format) can trigger the CSI report corresponding to the CSI report configuration information (for example, the CSI report is carried by the PUSCH), and the DCI can indicate a triggering state. Optionally, the triggering state is associated with the N sub-configuration(s) (among the L sub-configuration(s)) (or, the triggering state may indicate N configuration(s)) for CSI report. Optionally, the DCI format can be a DCI format 0_1 or a DCI format 0_2. For example, if the CSI report configuration information corresponds to an aperiodic CSI report, and the CSI report configuration information includes (or is configured with) L sub-configuration(s), DCI (or a DCI format) can trigger the CSI report corresponding to the CSI report configuration information (for example, the CSI report is carried by the PUSCH), and the DCI can indicate a triggering state. Optionally, the triggering state is associated with the N sub-configuration(s) (among the L sub-configuration(s)) (or, the triggering state indicates N configuration(s)) for CSI report. Optionally, the DCI format can be a DCI format 0_1 or a DCI format 0_2. Optionally, that the CSI report configuration information corresponds to the semi-persistent CSI report on the PUCCH means that the report type parameter (reportConfigType) in the CSI report configuration information (for example, CSI-ReportConfig) is set to “semiPersistentOnPUCCH”. Optionally, that the CSI report configuration information corresponds to the semi-persistent CSI report on the PUSCH means that a report type parameter (reportConfigType) in the CSI report configuration information (for example, CSI-ReportConfig) is set to “semiPersistentOnPUSCH”. Optionally, that the CSI report configuration information corresponds to the aperiodic CSI report means that a report type parameter (reportConfigType) in the CSI report configuration information (for example, CSI-ReportConfig) is set to “aperiodic”.

Optionally, the descriptions of the second sub-configuration in this disclosure can be applied to one sub-configuration or each sub-configuration or any sub-configuration of the one or more first sub-configuration(s). Optionally, the descriptions of the second sub-configuration in this disclosure can be applied to one sub-configuration or each sub-configuration or any sub-configuration in the subset of the one or more first sub-configuration(s). Optionally, in this disclosure, the second sub-configuration may be equivalent to one or more first sub-configuration(s). Optionally, in this disclosure, the second sub-configuration may be equivalent to the first sub-configuration.

Optionally, one of the one or more first sub-configuration(s) or the second sub-configuration may be referred to as a sub-configuration. Optionally, the sub-configuration may include/indicate/configure/be associated with at least one of the following:
A port parameter. Optionally, the port parameter is used to indicate a port subset (for example, an antenna port subset). For example, the port parameter may indicate a channel state information reference signal (CSI-RS) port. For example, the port parameter is a bitmap. Optionally, a length of the bitmap is equal to a number of ports of a reference signal resource used for channel measurement (for example, the number is indicated by a port parameter number parameter nrofPort). Optionally, the reference signal resource is a reference signal resource corresponding to the CSI report configuration information. Optionally, each bit of the bitmap corresponds to a port (e.g., an antenna port) of the reference signal resource in a one-to-one manner. A number of ports indicated by the sub-configuration is a number of bits ‘1’ (or ‘0’) in the bitmap. Here, ‘0’ represents/indicates that the corresponding port is disabled (or off or not used) in the corresponding sub-configuration. Here, ‘1’ represents/indicates that the corresponding port is enabled (or on or used) in the corresponding sub-configuration. Here, the definitions of bit value ‘0’ and bit value ‘1’ are exemplary, and their definitions can be interchanged. When the port parameter is not configured, the corresponding port of this sub-configuration may be a port (for example, all ports) of CSI-RS resources (for channel measurement) associated with the CSI report configuration information.
A codebook parameter. Optionally, the codebook parameter may include/indicate at least one of a first dimension parameter (N1), a second dimension parameter (N2), a parameter (Ng) for a panel/multi-panel (or for a codebook of a panel/multi-panel), and a codebook restriction (or a codebook subset restriction). For example, the codebook subset restriction issued to indicate a reported precoding matrix indicator (PMI) that is not allowed. For example, when the CSI report configuration information corresponds to/is associated with a (type I) single-panel codebook (for example, a codebook type parameter codebookType is set to ‘typeI-SinglePanel’) or the sub-configuration corresponds to/is associated with a (type I) single-panel codebook, the sub-configuration may include/indicate the first dimension parameter (N1) and the second dimension parameter (N2). For example, when the CSI report configuration information corresponds to/is associated with a (type I) multi-panel codebook (for example, a codebook type parameter codebookType is set to ‘typeI-MultiPanel’) or the sub-configuration corresponds to/is associated with a (type I) multi-panel codebook, the sub-configuration may include/indicate the first dimension parameter (N1) the second dimension parameter (N2), and the parameter (Ng) for the panel/multi-panel (or for the codebook of the panel/multi-panel). Optionally, when Ng is configured, the sub-configuration corresponds to a multi-panel codebook. Optionally, when Ng is not configured, the sub-configuration corresponds to a single-panel codebook. Optionally, when a configured value of Ng is greater than 1, the sub-configuration corresponds to the multi-panel codebook. Optionally, when the configured value of Ng is equal to 1, the sub-configuration corresponds to the single-panel codebook. The advantage of this is that the Ng parameter can be used to implicitly indicate a codebook type of the sub-configuration, thus reducing signalling overheads and clarifying the behavior of the terminal device.
A codebook type parameter. Optionally, the codebook type parameter is used to indicate that the sub-configuration corresponds to a (type I) single-panel codebook or a (type I) multi-panel codebook. If the parameter is not configured, the sub-configuration determines the codebookType based on the parameter (e.g., codebookType) indicated/configured in the CSI report configuration information. For example, the codebook type parameter codebookType is set to ‘typeI-SinglePanel’, indicating the (type I) single-panel codebook. For example, the codebook type parameter codebookType is set to ‘typeI-MultiPanel’, which indicates the (type I) multi-panel codebook. The advantage of this is that the parameter can be used to explicitly indicate a codebook type of the sub-configuration, thus clarifying the behavior of the terminal device.
A codebook mode parameter. Optionally, the codebook type parameter is used to indicate whether the sub-configuration corresponds to a mode 1 or a mode 2. If the parameter is not configured, the sub-configuration determines a codebook mode based on the parameter (for example, codebookMode) indicated/configured in the CSI report configuration information. For example, the codebook type parameter codebookMode is set to ‘l’, indicating a codebook mode 1. For example, the codebook type parameter codebookMode is set to ‘2’, indicating a codebook mode 2. The advantage of this is that the parameter can be used to explicitly indicate a codebook mode, thus clarifying the behavior of the terminal device.
A rank restriction parameter. Optionally, the rank restriction parameter is used to indicate the limitation of a rank indicator (RI) of the sub-configuration. For example, this parameter can indicate which rank values are allowed to be reported and which values are not allowed to be reported. Optionally, when a sub-configuration does not indicate/configure/is not associated with/include a rank restriction parameter, the reported rank (or a value of the rank) of the sub-configuration is determined based on the rank restriction parameter in the CSI report configuration information. Optionally, when a sub-configuration indicates/configures/is associated with/includes a rank restriction parameter, the reported rank is determined based on the rank restriction parameter indicated by/configured by/associated with/included by the (corresponding) sub-configuration.
One or more resources. Optionally, the sub-configuration indicates one or more resources (corresponding to the sub-configuration). Optionally, the sub-configuration may indicate the one or more resources (corresponding to the sub-configuration) via one or more parameters (e.g., list parameters). The one or more parameters indicate one or more resources (respectively). Optionally, the list parameters may include one or more resource identifiers (IDs) for indicating the one or more resources. Optionally, the one or more resources come from a resource set corresponding to/associated with the CSI report configuration information (for example, a resource set for channel measurement and/or interference measurement). For example, the resource set is NZP-CSI-RS-ResourceSet. Optionally, the resource may be used for channel measurement or for interference measurement. Optionally, the resource may be a reference signal resource. Optionally, the resource may be a non-zero power (NZP) CSI-RS resource. Optionally, the reference signal resource may be a channel state information interference measurement (CSI-IM) resource. Optionally, CSI corresponding to the sub-configuration is computed/determined based on the one or more resources.
A channel quality indicator (CQI) table parameter. Optionally, the CQI table parameter is used to indicate a CQI table corresponding to the sub-configuration. For example, the CSI (e.g., CQI) corresponding to the sub-configuration is computed/determined based on the CQI table.
A power parameter. Optionally, the power parameter is used to indicate power of one or more resources corresponding to the sub-configuration. For example, the power of the one or more resources (for channel measurement) is determined based on the power parameter and power parameters (respectively) configured for the one or more resources. For example, one resource is configured with one power parameter (for example, powerControlOffset), and for this resource, CSI computation/CSI determining is based on a sum of the power parameter indicated by the sub-configuration and the configured power parameters. For example, the sub-configuration power parameters include selection/indication parameters corresponding to the one or more resources. One resource is configured with one or more power parameters (for example, powerControlOffset), for this resource, CSI computation/CSI determining is based on power parameters (for example, powerControlOffset) indicated/selected for the corresponding selection/indication parameter.
A frequency domain granularity parameter. Optionally, this parameter is used to indicate a frequency domain granularity of the corresponding sub-configuration. Here, the frequency domain granularity may be a wideband frequency domain granularity or a subband frequency domain granularity. Here, the frequency domain granularity may be a wideband frequency domain granularity, or a wideband frequency domain granularity and a subband frequency domain granularity.

Optionally, the UE determines the CSI based on the one or more first sub-configuration(s) or the second sub-configuration(s). Optionally, the CSI may be CSI parameter(s). Optionally, determining the CSI parameter(s) may be computing the CSI parameter(s). Optionally, determining the CSI parameter(s) may be determining CSI feedback. Determining the CSI parameter(s) can also be determining the report carrying the CSI parameter(s) (that is, determining the CSI report). Optionally, the CSI parameter(s) may be CSI feedback. The CSI parameter(s) can be a report carrying the CSI parameter(s) (for example, the CSI report).

Optionally, the UE may receive a DCI. Optionally, the DCI triggers aperiodic reporting. Optionally, the DCI (or a CSI request field in the DCI) may trigger one or more CSI reports (on a PUSCH). For example, the one or more CSI reports are carried by the PUSCH. Optionally, the one or more CSI reports include one first CSI report.

Optionally, the one or more CSI reports include/correspond to one first CSI report. For example, the first CSI report represents an n-th (triggered) report among one or more report(s).

Optionally, the UE determines/feedbacks/reports the first CSI report (or the UE provides one (valid) CSI report for the first CSI report). Optionally, when at least one of the following conditions is met, the UE determines/feedbacks/reports the first CSI report (or the UE provides one (valid) CSI report for the first CSI report):
the time unit to carry the one or more CSI report(s) starts no earlier than the first time unit. For example, the unit of the time unit may be slot or symbol. For example, the time unit to carry the one or more CSI report(s) may be the first uplink symbol to carry the one or more CSI report(s). Optionally, the uplink symbol includes (or needs to consider) the effect of the timing advance. Descriptions of the first time unit (e.g., Z_{ref}) is given above.
the time unit to carry the first CSI report starts no earlier than at second time unit. For example, the unit of the time unit may be slot or symbol. For example, the time unit to carrying the first CSI report may be the first uplink symbol to carry the first CSI report. Optionally, the uplink symbol includes (or needs to consider) the effect of the timing advance. Descriptions of the second time unit is given above.

When the CSI report corresponds to one or multiple sub-configuration(s), the measurement resource corresponding to the CSI report (for example, the measurement resource corresponding to the CSI report for determining the second time unit) needs further explanation, otherwise, the terminal device and the network device are unclear about the second time unit. The method provided below can define the measurement resource corresponding to the CSI report, avoiding inconsistency of understanding of the terminal device and the network device, and improving the reliability of the communication system. Optionally, when the first CSI report corresponds to one or multiple first sub-configuration(s), the measurement resource(s) corresponding to the first CSI report (described in the above conditions/related to the second time unit) may be measurement resource corresponding to one (or each, or all) of the plurality of first sub-configuration(s) or one (or each, or all) of the second sub-configuration(s) corresponding to the first CSI report. For example, the measurement resource(s) corresponding to the first CSI report refer to resource(s) corresponding to the plurality of first sub-configuration(s) (L sub-configuration(s)) or the second sub-configuration (N sub-configuration(s)) corresponding to the first CSI report. Optionally, the second sub-configuration (N sub-configuration(s)) is indicated by the triggering state of the DCI (or indicated by the triggering state corresponding to the DCI). Optionally, the resource(s) corresponding to the plurality of first sub-configuration(s) (L sub-configuration(s)) or second sub-configuration(s) (N sub-configuration(s)) may be a (corresponding) measurement resource(s) of all sub-configuration(s) corresponding to the plurality of first sub-configuration(s) (the L sub-configuration(s)) or (corresponding) measurement resource(s) of all sub-configuration(s) corresponding to the second sub-configuration (the N sub-configuration(s)).

Optionally, measurement resource(s) corresponding to at least one (or each) sub-configuration of the plurality of first sub-configuration(s) or the second sub-configuration is determined based on an (explicit) indication of the sub-configuration. Optionally, a measurement resource corresponding to at least one (or each) sub-configuration of the plurality of first sub-configuration(s) or the second sub-configuration is determined based on a resource set corresponding to the CSI report configuration information. Optionally, when a first condition is met, the resource corresponding to the sub-configuration is determined based on the resource set corresponding to the CSI report configuration information (for example, all resources in the set). Optionally, when a second condition is met, that the sub-configuration corresponds to one resource (or a single resource) is determined based on the (explicit) indication of the sub-configuration.

For example, resource(s) corresponding to one sub-configuration can be determined based on one or more resources indicated by the sub-configuration. The one or more resources are indicated, for example, by the list parameter. For example, resource(s) corresponding to one sub-configuration can be determined by resource set included in/associated with/corresponding to the CSI report configuration information. For example, one or more resources corresponding to the sub-configuration refer to (all) resources in the resource set. Optionally, the set corresponds to a resource set associated with/corresponding to the CSI report configuration information (for example, NZP-CSI-RS-ResourceSet). Optionally, the resource set is in a CSI resource setting corresponding to the CSI report configuration information. Optionally, the CSI resource setting is used for channel measurement and/or interference measurement. For example, the CSI resource setting can be associated with/corresponding to a channel measurement resource parameter (for example, resourcesForChannelMeasurement) in the CSI report configuration information. For example, the CSI resource setting may be associated with/corresponding to a parameter that is used to indicate an interference measurement resource and that is in the CSI report configuration information. The CSI resource setting is, for example, CSI-ResourceConfig. Optionally, the resource may be reference signal resource. Optionally, the reference signal resource may be reference signal. Optionally, the resource includes CSI-RS resource or CSI-IM resource. Optionally, CSI-RS may be NZP CSI-RS.

When the CSI report corresponds to one or more sub-configuration(s), a CSI computation delay parameter corresponding to the CSI report is unclear. The method provided below can clarify the CSI computation delay parameter corresponding to the CSI report, avoiding inconsistency of understanding of the terminal device and the network device, and improving the reliability of the communication system. Optionally, when the first CSI report corresponds to one or more first sub-configuration(s), a CSI computation delay parameter corresponding to the first CSI report is based on a plurality of first sub-configuration(s) or a second sub-configuration. Optionally, the UE determines the CSI computation delay parameter of the CSI report corresponding to the CSI report configuration information based on the plurality of first sub-configuration(s) or the second sub-configuration. Optionally, the CSI computation delay parameter is used to determine/represent the CSI computation delay parameter. Optionally, the CSI computation delay parameter associated with the first time unit may be Z₁ and/or Z₂. Optionally, the CSI computation delay parameter associated with the first time unit may be Z′₁ and/or Z′₂. For example, for report m, a CSI computation delay parameter Z(m) associated with the first time unit may be Z₁ and/or Z₂. For example, for one report m, a CSI computation delay parameter Z′(m) associated with the second time unit may be Z′₁ and/or Z′₂. A method for determining a CSI computation delay parameter is further described below, for example, a mapping relationship between Z(m) and Z₁ and/or Z₂, for example, a mapping relationship between Z′(m) and Z′₁ and/or Z′₂.

For example, Z₁, Z₂, Z′₁, and Z′₂ can be represented by Table 1 below. Here, μ in Table 1 corresponds to a minimum value min (μ_{PDCCH}, μ_{CSI-RS}, μ_{UL}) of μ_{PDCCH}, μ_{CSI-RS}, and μ_{UL}. Here, μ_{PDCCH} corresponds to a subcarrier interval of a physical downlink control channel (PDCCH), wherein the DCI (for example, the DCI that triggers the CSI report) is carried/transmitted through the PDCCH. μ_{UL} corresponds to a subcarrier interval of a PUSCH, wherein the PUSCH is used to carry/send the CSI report. μ_{CSI-RS} corresponds to a minimum/maximum subcarrier interval in an aperiodic CSI-RS triggered by the DCI. Optionally, the aperiodic CSI-RS triggered by the DCI refers to (one or more) resource (e.g., CSI-RS resource) indicated by (all) sub-configuration triggered by the DCI. Optionally, when the second condition is met, the aperiodic CSI-RS triggered by the DCI refers to (one or more) resource (e.g., CSI-RS resource) indicated by (all) sub-configuration triggered by the DCI. For example, if the DCI triggers three configurations: a sub-configuration #1, a sub-configuration #2, and a sub-configuration #3. Among them, the sub-configuration #1 includes one list parameter indicating a resource #1, a resource #2, and a resource #3. The sub-configuration #2 includes one list parameter indicating a resource #4 and a resource #5. The sub-configuration #3 includes one list parameter indicating a resource #6 and a resource #7. Then, resources indicated by the sub-configuration(s) triggered by the DCI are the resource #1, the resource #2, the resource #3, the resource #4, the resource #5, the resource #6, and the resource #7.

TABLE 1

| | [Symbol] | | [Symbol] | |
|---|---|---|---|---|
| μ | Z₁ | Z′₁ | Z₂ | Z′₂ |
| 0 | 22 | 16 | 40 | 37 |
| 1 | 33 | 30 | 72 | 69 |
| 2 | 44 | 42 | 141 | 140 |
| 3 | 97 | 85 | 152 | 140 |
| 5 | 388 | 340 | 608 | 560 |
| 6 | 776 | 680 | 1216 | 1120 |

Optionally, when a plurality of first sub-configuration(s) or a second sub-configuration meet a condition A, the UE determines the CSI computation delay parameter of the CSI report (for example, the first CSI report) corresponding to the CSI report configuration information. Optionally, the CSI computation delay parameter is a first CSI computation delay parameter. Optionally, the CSI report configuration information may correspond to N sub-configuration(s) (or L sub-configuration(s)). Optionally, CSI corresponding to the N sub-configuration(s) (or the L sub-configuration(s)) is in the CSI report triggered by the DCI (or in a PUSCH triggered by the DCI). Here, the first CSI computation delay parameter may be Z₁ and/or Z′₁ (or, Z₂ and/or Z′₂). The first CSI computation delay parameter may also be referred to as a first parameter value. For example, when the condition A is met, the CSI computation delay parameter corresponding to the first CSI report is the first CSI computation delay parameter (Z₁ and/or Z′₁). Optionally, the condition A may include at least one of the following:
At least one (or each) sub-configuration of a plurality of first sub-configuration(s) or a second sub-configuration corresponds to a single-panel or does not report a PMI parameter. For example, the at least one (or each) sub-configuration of the plurality of first sub-configuration(s) or the second sub-configuration determines CSI based on a single-panel codebook. For example, the at least one (or each) sub-configuration of the plurality of first sub-configuration(s) or the second sub-configuration does not report the PMI parameter.
The at least one (or each) sub-configuration of the plurality of first sub-configuration(s) or the second sub-configuration corresponds to one resource. For example, a number of resources corresponding to the at least one (or each) sub-configuration of the plurality of first sub-configuration(s) or the second sub-configuration is 1. For example, the at least one (or each) sub-configuration of the plurality of first sub-configuration(s) or the second sub-configuration corresponds to a single resource. Optionally, the resource may be a (CSI-RS) resource for channel measurement.
A number of ports of the resource corresponding to the at least one (or each) sub-configuration of the plurality of first sub-configuration(s) or the second sub-configuration is less than or equal to a specific value. Optionally, the port may be a port of a (CSI-RS) resource for channel measurement. Optionally, the specific value may be at least one of 1, 2, 4, and 8. Optionally, the specific value may be indicated by the base station (for example, by an RRC signalling or a MAC-CE signalling or a DCI signalling). Optionally, the specific value may be based on a UE capability (for example, the specific value is indicated by a capability signalling reported by the UE).
The at least one (or each) sub-configuration of the plurality of first sub-configuration(s) or the second sub-configuration does not report CRI. For example, when one of the sub-configuration(s) corresponds to one resource, CRI of the sub-configuration does not need to be reported.
The at least one (or each) sub-configuration of the plurality of first sub-configuration(s) or the second sub-configuration corresponds to a wideband frequency domain granularity. For example, the at least one (or each) sub-configuration of the plurality of first sub-configuration(s) or the second sub-configuration corresponds (only) to the wideband frequency domain granularity (or, corresponds to a wideband granularity but does not correspond to a sub-band granularity). For example, the at least one (or each) sub-configuration of the plurality of first sub-configuration(s) or the second sub-configuration determines the CSI based on (the assumption of) the wideband frequency domain granularity.
A number of sub-configuration(s) corresponding to the plurality of first sub-configuration(s) or the second sub-configuration is less than or equal to a specific value. Here, a number of sub-configuration(s) of the plurality of first sub-configuration(s) is, for example, L. Here, a number of sub-configuration(s) corresponding to the second sub-configuration is, for example, N. Optionally, the specific value may be at least one of 1, 2, 3, 4, and 8. Optionally, the specific value may be indicated by the base station (for example, by an RRC signalling or a MAC-CE signalling or a DCI signalling). Optionally, the specific value may be based on a UE capability (for example, the specific value is indicated by a capability signalling reported by the UE).

The parameters/concepts in the condition A are further described below.

Optionally, that the at least one (or each) sub-configuration of the plurality of first sub-configuration(s) or the second sub-configuration corresponds to the single-panel codebook or does not report the PMI parameter is determined based on indication of the sub-configuration. Optionally, that the at least one (or each) sub-configuration of the plurality of first sub-configuration(s) or the second sub-configuration corresponds to the single-panel codebook or does not report the PMI parameter is determined based on a codebook type corresponding to the CSI report configuration information. For example, a single-panel codebook corresponding to one sub-configuration can be determined by a parameter indicated in the sub-configuration. For a specific determining method, refer to the descriptions of the parameter indicated in the sub-configuration above. For example, a single-panel codebook corresponding to one sub-configuration can be determined based on a parameter (e.g., CodebookConfig) that is used to configure a codebook and that is included in/associated with/corresponding to the CSI report configuration information. For example, a single-panel codebook corresponding to one sub-configuration can be determined based on a parameter (e.g., codebookType) that is used to indicate a codebook type among parameters (e.g., CodebookConfig) used to configure a codebook and that is included in/associated with/corresponding to the CSI report configuration information. For example, does not report PMI parameter corresponding to one sub-configuration can be determined based on a parameter indicated in the sub-configuration. For example, the sub-configuration includes or corresponds to one parameter indicating a reporting quantity of the sub-configuration, and the reporting quantity parameter indicates the sub-configuration to report a CRI parameter, an RI parameter and a CQI parameter. For example, a single-panel codebook corresponding to one sub-configuration can be determined based on a parameter (e.g., reportQuantity) that is used to configure the reporting quantity and that is included in/associated with/corresponding to the CSI report configuration information. For example, a value of the parameter used to configure the reporting quantity is equal to cri-RI-CQI or the parameter used to configure the reporting quantity indicates (a CSI report) to report the CRI parameter, the RI parameter, and the CQI parameter.

When the CSI report corresponds to one or more sub-configuration(s), it is unclear which resources the sub-configuration(s) correspond to (especially when the CSI computation delay parameter is determined). The method provided below can clarify a resource (or a number of corresponding resources) corresponding to the sub-configuration, avoiding inconsistency of understanding of the terminal device and the network device, and improving the reliability of the communication system. Optionally, that at least one (or each) sub-configuration of the plurality of first sub-configuration(s) or the second sub-configuration corresponds to one resource (or a single resource) is determined based on an indication of the sub-configuration. Optionally, that at least one (or each) sub-configuration of the plurality of first sub-configuration(s) or the second sub-configuration corresponds to one resource is determined based on the resource set corresponding to the CSI report configuration information. Optionally, when the first condition is met, that the sub-configuration corresponds to one resource is determined based on the resource set corresponding to the CSI report configuration information. Optionally, when a second condition is met, that the sub-configuration corresponds to one resource (or a single resource) is determined based on the indication of the sub-configuration.

For example, a resource corresponding to one sub-configuration can be determined based on one or more resources indicated in the sub-configuration. The one or more resources are indicated, for example, by the list parameter. For example, a resource corresponding to one sub-configuration can be determined by a resource set included in/associated with/corresponding to the CSI report configuration information. For example, a number of resources included in this resource set is 1. Optionally, the set corresponds to a resource set associated with/corresponding to the CSI report configuration information (for example, NZP-CSI-RS-ResourceSet). Optionally, the resource set is in a CSI resource setting corresponding to the CSI report configuration information. Optionally, the CSI resource setting is used for channel measurement. For example, the CSI resource setting can be associated with/corresponding to a channel measurement resource parameter (for example, resourcesForChannelMeasurement) in the CSI report configuration information. The CSI resource setting is, for example, a CSI-ResourceConfig parameter. Optionally, the resource may be a reference signal resource. Optionally, the reference signal resource may be a reference signal. Optionally, the resource includes a CSI-RS resource or a CSI-IM resource. Optionally, a CSI-RS may be an NZP CSI-RS.

When the CSI report corresponds to one or more sub-configuration(s), a number of ports of the resource corresponding to the sub-configuration(s) is unclear (especially when the CSI computation delay parameter is determined). The method provided below can clarify a number of ports of a resource corresponding to the CSI report/the sub-configuration, avoiding inconsistency of understanding of the terminal device and the network device, and improving the reliability of the communication system. Optionally, the number of ports of the resource corresponding to the at least one (or each) sub-configuration of the plurality of first sub-configuration(s) or the second sub-configuration is determined based on an indication of the sub-configuration. Optionally, the number of ports of the resource corresponding to the at least one (or each) sub-configuration of the plurality of first sub-configuration(s) or the second sub-configuration is determined based on a number of ports of a resource in the resource set corresponding to the CSI report configuration information. Optionally, when the first condition is met, the number of ports of the resource corresponding to the sub-configuration is determined based on the indication of the sub-configuration. Optionally, when the second condition is met, the number of ports of the resource corresponding to the sub-configuration is determined based on the resource set corresponding to the CSI report configuration information.

For example, a number of ports of a resource corresponding to one sub-configuration can be determined based on a port parameter indicated in the sub-configuration. For example, a resource corresponding to one sub-configuration can be determined based on the number of ports of the resource in the resource set included in/associated with/corresponding to the CSI report configuration information. Here, the descriptions of the resource set can be found above. Optionally, a number of ports of a resource refers to a number of ports indicated by a port number parameter (for example, nrofPorts) corresponding to the resource. Optionally, the port number parameter is used to define the number (or total number) of ports of the corresponding resource.

Optionally, when the plurality of first sub-configuration(s) or the second sub-configuration meets a condition B, the UE determines a CSI computation delay parameter of a CSI report corresponding to the CSI report configuration information. Optionally, the CSI computation delay parameter is a second CSI computation delay parameter. Optionally, the CSI report configuration information may include/correspond to L sub-configuration(s) or N sub-configuration(s). Here, the second CSI computation delay may be Z₂ and/or Z′₂ (or, Z₁ and/or Z′₁). The second CSI computation delay parameter may also be referred to as a second parameter value. For example, when the condition B is met, the CSI computation delay parameter corresponding to the first CSI report is the second CSI computation delay parameter (Z₂ and/or Z′₂). Optionally, the condition B may include at least one of the following:
The condition A is not met. For example, that the plurality of first sub-configuration(s) or the second sub-configuration meets the condition B can be understood as that the plurality of first sub-configuration(s) or the second sub-configuration does not meet the condition A.
At least one (or each) of the plurality of first sub-configuration(s) or the second sub-configuration(s) corresponds to a multi-panel. For example, the at least one (or each) sub-configuration of the plurality of first sub-configuration(s) or the second sub-configuration determines CSI based on a multi-panel codebook.
The at least one (or each) sub-configuration of the plurality of first sub-configuration(s) or the second sub-configuration corresponds to a plurality of resources. For example, a number of resources corresponding to the at least one (or each) sub-configuration of the plurality of first sub-configuration(s) or the second sub-configuration is greater than (or equal to) 1. For example, the at least one (or each) sub-configuration of the plurality of first sub-configuration(s) or the second sub-configuration corresponds to a plurality of resources. Optionally, the resource may be a (CSI-RS) resource for channel measurement.
A number of ports of the resource corresponding to the at least one (or each) sub-configuration of the plurality of first sub-configuration(s) or the second sub-configuration is greater than or equal to a specific value. Optionally, the port is a port of a (CSI-RS) resource for channel measurement. Optionally, the specific value may be at least one of 1, 2, 4, and 8. Optionally, the specific value may be indicated by the base station (for example, by an RRC signalling or a MAC-CE signalling or a DCI signalling). Optionally, the specific value may be based on a UE capability (for example, the specific value is indicated by a capability signalling reported by the UE).
The at least one (or each) sub-configuration of the plurality of first sub-configuration(s) or the second sub-configuration reports the CRI. For example, when one sub-configuration corresponds to a plurality of resources, the sub-configuration reports the CRI (or needs to report the CRI).
The at least one (or each) sub-configuration of the plurality of first sub-configuration(s) or the second sub-configuration corresponds to a sub-band frequency domain granularity. For example, the at least one (or each) sub-configuration of the plurality of first sub-configuration(s) or the second sub-configuration corresponds (only) to the sub-band frequency domain granularity. For example, the at least one (or each) sub-configuration of the plurality of first sub-configuration(s) or the second sub-configuration determines CSI based on (the assumption of) the sub-band frequency domain granularity.
A number of sub-configuration(s) corresponding to the plurality of first sub-configuration(s) or the second sub-configuration is greater than or equal to a specific value. Here, a number of sub-configuration(s) of the plurality of first sub-configuration(s) is, for example, L. Here, a number of sub-configuration(s) corresponding to the second sub-configuration is, for example, N. Optionally, the specific value may be at least one of 1, 2, 3, 4, and 8. Optionally, the specific value may be indicated by the base station (for example, by an RRC signalling or a MAC-CE signalling or a DCI signalling). Optionally, the specific value may be based on a UE capability (for example, the specific value is indicated by a capability signalling reported by the UE).

For further descriptions of the parameters/concepts in the condition B, refer to the descriptions of the parameters/concepts in the condition A.

Optionally, a CSI computation delay parameter of a CSI report corresponding to the CSI report configuration information is a CSI computation delay parameter with the largest/smallest value among a CSI computation delay parameter corresponding to each of the plurality of first sub-configuration(s) or the second sub-configuration. Optionally, the CSI report may include L sub-configuration(s) or N sub-configuration(s). In this method, each of the plurality of first sub-configuration(s) or the second sub-configuration (in other words, each of the L sub-configuration(s) or the N sub-configuration(s)) can compute/determine one corresponding CSI computation delay parameter. For one sub-configuration/each sub-configuration, a corresponding CSI computation delay parameter is determined based on the condition A and/or the condition B. For example, when one sub-configuration meets the condition A, a CSI computation delay parameter corresponding to the sub-configuration is a first CSI computation delay parameter (for example, Z₁ and/or Z′₁). For example, when one sub-configuration meets the condition B, a CSI computation delay parameter corresponding to the sub-configuration is a second CSI computation delay parameter (for example, Z₂ and/or Z′₂). Here, a value of the CSI computation delay parameter can represent a number of symbols (as shown in Table 1, for example). For example, a value of the first CSI computation delay parameter is less than or equal to a value of the second CSI computation delay parameter. For example, under a same subcarrier interval, the first CSI computation delay parameter (Z₁) in Table 1 is less than or equal to the corresponding second CSI computation delay parameter (Z₂) in Table 1. For example, the CSI report corresponds to N sub-configuration(s), and a CSI computation delay parameter corresponding to the CSI report is a CSI computation delay parameter with the largest value among the N sub-configuration(s). For example, the CSI report corresponds to L sub-configuration(s), and a CSI computation delay parameter corresponding to the CSI report is a CSI computation delay parameter with the largest value among the L sub-configuration(s).

Optionally, the CSI computation delay parameter of the CSI report corresponding to the CSI report configuration information is predefined. For example, the CSI computation delay parameter of the CSI report corresponding to the CSI report configuration information is the first CSI computation delay parameter (for example, Z₁ and/or Z′₁). For example, the CSI computation delay parameter of the CSI report corresponding to the CSI report configuration information is the second CSI computation delay parameter (for example, Z₂ and/or Z′₂).

The details of the first condition and the second condition are described below.

Optionally, the first condition includes at least one of the following:
The second condition is not met. That is, when the second condition is not met, the UE determines a second CSI parameter of the second sub-configuration based on a first CSI parameter indicated by the second sub-configuration. Descriptions of the second condition is given below.
The second sub-configuration is configured with a type I parameter. Optionally, the type I parameter is used to indicate type I adaptation.
(One or all of) one or more first sub-configuration(s) are configured with type I parameters. Optionally, the type I parameter is used to indicate type I adaptation.
One or more first sub-configuration(s) have different CSI-RS ports (or a subset of CSI-RS ports). Optionally, the CSI-RS ports refer to CSI-RS ports (or a port subset) indicated by the second sub-configuration. Optionally, the CSI-RS port may be a CSI-RS port for channel measurement. The CSI port can be a CSI-RS antenna port. Optionally, the CSI-RS port corresponds to a resource (e.g., a reference signal resource) for channel measurement.
The second sub-configuration includes/corresponds to/is associated with/indicates a port subset. Optionally, the port subset refers to a port subset of the CSI-RS (or a subset of CSI-RS antenna ports). Optionally, the port subset refers to a port subset (or a subset of CSI-RS antenna ports) of the CSI-RS (for channel measurement) of the second sub-configuration.
(One or all of) one or more first sub-configuration(s) include/correspond to/are associated with/indicate a port subset. Optionally, the (one or all of) the one or more first sub-configuration(s) include/correspond to/are associated with/indicate different subsets of ports (for example, subsets of CSI-RS antenna ports). Optionally, CSI-RS resources corresponding to the port subset are used for channel measurement and/or interference measurement.
A number of resources for channel measurement in the second sub-configuration is greater than 1. Optionally, a number of reference signal resources for channel measurement in the second sub-configuration is greater than 1.
A number of resources that are used for channel measurement and that correspond to CSI configuration information is greater than 1. Optionally, the number of reference signal resources for channel measurement in the second sub-configuration is greater than 1. For example, a number of reference signal resources in a resource set (for channel measurement) corresponding to the CSI configuration information (for example, NZP-CSI-RS-ResourceSet) is greater than 1.
The CSI configuration information corresponds to an aperiodic CSI report or one of a semi-persistent CSI report and an aperiodic CSI report.
The resource for channel measurement and/or interference measurement in the second sub-configuration is aperiodic. Optionally, a resource type parameter (for example, resourceType) of a CSI resource setting (CSI-ResourceConfig) (for channel measurement and/or interference measurement) corresponding to the CSI report configuration information of the second sub-configuration is set to “aperiodic”.
resources for channel measurement and/or interference measurement t included in/corresponding to/associated with/indicated by the (one or all of) one or more first sub-configuration(s) are aperiodic. Optionally, a resource type parameter (for example, resourceType) of a CSI resource setting (CSI-ResourceConfig) (for channel measurement and/or interference measurement) corresponding to the CSI report configuration information of the one or more first sub-configuration(s) is set to “aperiodic”.

Optionally, the second condition includes at least one of the following:
The first condition is not met. That is, when the first condition is not met, the UE determines a second CSI parameter of the second sub-configuration based on a first CSI parameter of the second sub-configuration. Descriptions of the first condition is given above.
The second sub-configuration is configured with a type II parameter. Optionally, the type II parameter is used to indicate type II adaptation.
(One or all of) one or more first sub-configuration(s) are configured with type II parameters. Optionally, the type II parameter is used to indicate type II adaptation.
The one or more first sub-configuration(s) have a same CSI-RS port. Optionally, the CSI-RS port refers to a CSI-RS port corresponding to a port number parameter (for example, nrofPorts). Optionally, the CSI-RS port may be a CSI-RS port for channel measurement. The CSI port can be a CSI-RS antenna port. Optionally, the CSI-RS port corresponds to a resource (e.g., a reference signal resource) for channel measurement.
The second sub-configuration includes/corresponds to/is associated with/indicates one or more resources. Optionally, the one or more resources are used for channel measurement and/or interference measurement. Optionally, the one or more resources are reference signal resources for channel measurement. Optionally, the one or more resources are reference signal resources for interference measurement. Optionally, the second sub-configuration includes/corresponds to/is associated with one or more lists indicating one or more resources (respectively). Optionally, the one or more (reference signal) resources include reference signal resources in a resource set (e.g., NZP-CSI-RS-ResourceSet). Optionally, the one or more resources include resources in a resource set (e.g., csi-IM-ResourceSet). Optionally, the resource set corresponds to the CSI report configuration information. For example, the resource set is in a CSI resource setting corresponding to the CSI report configuration information. The CSI resource setting is, for example, a CSI-ResourceConfig.
The (one or all of) one or more first sub-configuration(s) include/correspond to/are associated with/indicate one or more resources. Optionally, the one or more resources are used for channel measurement and/or interference measurement. Optionally, the second sub-configuration includes/corresponds to/is associated with one or more lists indicating one or more resources. Optionally, the one or more resources include reference signal resources in a resource set (e.g., NZP-CSI-RS-ResourceSet). Optionally, the one or more resources include resources in a resource set (e.g., csi-IM-ResourceSet). Optionally, the resource set corresponds to the CSI report configuration information. For example, the resource set is in a CSI resource setting corresponding to the CSI report configuration information. The CSI resource setting is, for example, a CSI-ResourceConFIG.
A number of resources for channel measurement in the second sub-configuration is greater than 1. Optionally, the number of reference signal resources for channel measurement in the second sub-configuration is greater than 1.
The CSI configuration information corresponds to an aperiodic CSI report or one of a semi-persistent CSI report and an aperiodic CSI report.
The resource for channel measurement and/or interference measurement in the second sub-configuration is aperiodic. Optionally, a resource type parameter (for example, resourceType) of a CSI resource setting (CSI-ResourceConfig) (for channel measurement and/or interference measurement) corresponding to the CSI report configuration information of the second sub-configuration is set to “aperiodic”.
resources for channel measurement and/or interference measurement included in/corresponding to/associated with/indicated by the (one or all of) one or more first sub-configuration(s) are aperiodic. Optionally, a resource type parameter (for example, resourceType) of a CSI resource setting (CSI-ResourceConfig) (for channel measurement and/or interference measurement) corresponding to the CSI report configuration information of the one or more first sub-configuration(s) is set to “aperiodic”.

The advantage of Embodiment 1 is that, when one or more sub-configuration(s) are configured for CSI report, the method of a CSI computation delay parameter of the CSI report corresponding to the one or more sub-configuration(s) is clarified, so that the terminal device can correctly determine, based on the CSI computation delay parameter, whether to discard the corresponding CSI report or CSI information, which improves the reliability of the communication system. In addition, clarifying the CSI computation delay parameter can help the terminal device hardware to design pertinently and reduce hardware costs.

### Embodiment 2

A UE receives CSI report configuration information (for example, CSI-ReportConfig). Optionally, the CSI report configuration information is associated with/corresponds to/includes one or more first sub-configuration(s). Here, a sub-configuration may be referred to as sub-configuration information. Optionally, the first sub-configuration may be sub-configuration information of a CSI report. Here, the CSI report configuration information may correspond to one CSI report, or the CSI report configuration information may be used to refer to one CSI report.

Optionally, a second sub-configuration includes one of the one or more first sub-configuration(s). Optionally, the second sub-configuration includes one of sub-configuration(s) in a subset of the one or more first sub-configuration(s). Here, for descriptions of the first sub-configuration and the second sub-configuration and the subset, refer to Embodiment 1.

Optionally, one of the one or more first sub-configuration(s) or the second sub-configuration may be referred to as a sub-configuration. Optionally, the sub-configuration may include/indicate/configure/be associated with at least one of the following:
A port parameter. Optionally, when a first condition is met, the sub-configuration may include/indicate/configure/be associated with the port parameter. For descriptions of the port parameter, refer to Embodiment 1.
A codebook parameter. Optionally, when the first condition is met, the sub-configuration may include/indicate/configure/be associated with the codebook parameter. For descriptions of the codebook parameter, refer to Embodiment 1.
A codebook type parameter. Optionally, when the first condition is met, the sub-configuration may include/indicate/configure/be associated with the codebook type parameter. For descriptions of the codebook type parameter, refer to Embodiment 1.
A rank restriction parameter. Optionally, when the first condition is met, the sub-configuration may include/indicate/configure/be associated with the rank restriction parameter. For descriptions of the rank restriction parameter, refer to Embodiment 1.
One or more resources. Optionally, when a second condition (or the first condition) is met, the sub-configuration may include/indicate/configure/be associated with the one or more resources. For descriptions of the one or more resources, refer to Embodiment 1.
A CQI table parameter. Optionally, when the second condition (or the first condition) is met, the sub-configuration may include/indicate/configure/be associated with the CQI table parameter. For descriptions of the CQI table parameter, refer to Embodiment 1.
A power parameter. Optionally, when the second condition (or the first condition) is met, the sub-configuration may include/indicate/configure/be associated with the power parameter. For descriptions of the power parameter, refer to Embodiment 1.
A frequency domain granularity parameter. For descriptions of the frequency domain granularity parameter, refer to Embodiment 1.

Optionally, the UE determines a CSI or report a CSI based on a plurality of first sub-configuration(s) or a second sub-configuration. Optionally, the CSI may be a CSI parameter. Optionally, determining the CSI parameter may be computing the CSI parameter. Optionally, determining the CSI parameter may be determining CSI feedback. Determining the CSI parameter can also be determining the report carrying the CSI parameter (that is, determining the CSI report). Optionally, the CSI parameter may be CSI feedback. The CSI parameter can also be a report carrying the CSI parameter (namely, the CSI report).

Optionally, the CSI parameter may be referred to as a CSI quantity. Optionally, the CSI parameter may be at least one of a CSI-RS resource indicator (CRI), a rank indicator (RI), a precoding matrix indicator (PMI), a channel quality indicator (CQI), and a layer indicator (LI). Optionally, the CSI parameter may be at least one of the CSI-RS resource indicator (CRI), a SSB resource indicator (SS/PBCH Block Resource indicator, SSBRI), a Layer 1 reference signal received power (LI-RSRP), a Layer 1 signal-to-interference-noise ratio (L1-SINR), and a capability index (CapabilityIndex).

Optionally, the CSI parameter (or, the first CSI parameter and/or the second CSI parameter) may be determined based on (a reporting quantity corresponding to) the CSI report configuration information. Optionally, the CSI parameter of (one/each of) the plurality of first sub-configuration(s) or the second sub-configuration may be determined based on (the reporting quantity corresponding to) the CSI report configuration information. Optionally, the CSI parameter (or the reporting quantity) corresponding to the CSI report configuration information may be at least one of the CRI, the RI, the LI, the PMI, and the CQI. Optionally, the reporting quantity parameter (for example, reportQuantity) included in the CSI report configuration information (for example, CSI-ReportConfig) may be at least one of the CRI, the RI, the LI, the PMI, and the CQI. For example, when the reportQuantity parameter is set to “cri-RI-LI-PMI-CQI”, corresponding CSI parameters (of the one or each of the plurality of first sub-configuration(s) or the second sub-configuration) are the CRI, the RI, the LI, the PMI, and the CQI. For example, when the reportQuantity parameter is set to “cri-RI-PMI-CQI”, corresponding CSI parameters (of the one or each of the plurality of first sub-configuration(s) or the second sub-configuration) are the CRI, the RI, the PMI, and the CQI. For example, when the reportQuantity parameter is set to “cri-RI-i1-CQI”, corresponding CSI parameters (of the one or each of the plurality of first sub-configuration(s) or the second sub-configuration) are the CRI, the RI, the PMI, and the CQI. For example, when the reportQuantity parameter is set to “cri-RI-i1”, corresponding CSI parameters (of the one or each of the first sub-configuration(s) or the second sub-configuration) are the CRI, the RI, and the PMI. For example, when the reportQuantity parameter is set to “cri-RI-CQI”, corresponding CSI parameters (of the one or each of the first sub-configuration(s) or the second sub-configurations) are the CRI, the RI, and the CQI.

Optionally, a maximum number of ports of a resource corresponding to at least one (or each) sub-configuration of the plurality of first sub-configuration(s) or the second sub-configuration is based on a number of resources corresponding to the plurality of first sub-configuration(s) or the second sub-configuration. Optionally, the number of resources corresponding to the plurality of first sub-configuration(s) or the second sub-configuration may be a maximum/minimum value of a number of resources corresponding to at least one (or each) sub-configuration of the plurality of first sub-configuration(s) or the second sub-configuration.

Optionally, when the second condition (or the first condition) is satisfied, a maximum number of ports of the resources corresponding to the at least one (or each) sub-configuration of the plurality of first sub-configuration(s) or the second sub-configuration is based on the maximum/minimum value of the number of resources corresponding to the at least one (or each) sub-configuration of the plurality of first sub-configuration(s) or the second sub-configuration. For example, one CSI report corresponds to two sub-configuration(s), namely, a sub-configuration #1 and a sub-configuration #2. The sub-configuration #1 corresponds to a resource #1 and a resource #2; and the sub-configuration #2 corresponds to a resource #3. A maximum number of resources corresponding to these sub-configuration(s) (the sub-configuration #1 and the sub-configuration #2) is 2.

Optionally, when a number of resources corresponding to the plurality of first sub-configuration(s) or the second sub-configuration is 1 and/or 2, a maximum number of ports corresponding to the at least one (or each) sub-configuration of the plurality of first sub-configuration(s) or the second sub-configuration is a specific value. Optionally, the specific value may be at least one of 16, 32, and 64. Optionally, the specific value may be indicated by a base station (for example, indicated by RRC or indicated by a MAC-CE, or indicated by DCI). Optionally, the specific value may be based on a UE capability. For example, the specific value is indicated by a capability signalling reported by the UE.

Optionally, when the number of resources corresponding to the plurality of first sub-configuration(s) or the second sub-configuration is 2, and/or 2, and/or 4, the maximum number of ports corresponding to the at least one (or each) sub-configuration of the plurality of first sub-configuration(s) or the second sub-configuration is a specific value. Optionally, the specific value may be at least one of 8, 16, 32, and 64. Optionally, the specific value may be indicated by a base station (for example, indicated by RRC or indicated by a MAC-CE, or indicated by DCI). Optionally, the specific value may be based on a UE capability. For example, the specific value is indicated by a capability signalling reported by the UE.

Optionally, when the number of resources corresponding to the plurality of first sub-configuration(s) or the second sub-configuration is greater than or equal to 2 (or 3 or 4) and less than or equal to 4 (or 8), the maximum number of ports corresponding to the at least one (or each) sub-configuration of the plurality of first sub-configuration(s) or the second sub-configuration is a specific value. Optionally, the specific value may be at least one of 8, 16, 32, and 64. Optionally, the specific value may be indicated by a base station (for example, indicated by RRC or indicated by a MAC-CE, or indicated by DCI). Optionally, the specific value may be based on a UE capability. For example, the specific value is indicated by a capability signalling reported by the UE.

When the CSI report corresponds to one or more sub-configuration(s), it is unclear which resources the sub-configuration(s) correspond to (especially when a maximum number of ports of a resource corresponding to the CSI report/the sub-configuration is determined). The method provided below can clarify a resource (or a number of corresponding resources) corresponding to the sub-configuration, avoiding inconsistency of understanding of the terminal device and the network device, and improving the reliability of the communication system. Optionally, a resource corresponding to the at least one (or each) sub-configuration of the plurality of first sub-configuration(s) or the second sub-configuration is determined based on an indication of the sub-configuration. Optionally, a resource corresponding to the at least one (or each) sub-configuration of the plurality of first sub-configuration(s) or the second sub-configuration is determined based on a resource set corresponding to the CSI report configuration information. Optionally, when the first condition is met, one resource corresponding to the sub-configuration is determined based on the resource set corresponding to the CSI report configuration information. Optionally, when the second condition is met, the resource corresponding to the sub-configuration is determined based on the indication of the sub-configuration.

For example, a resource corresponding to one sub-configuration can be determined based on one or more resources indicated in the sub-configuration. The one or more resources are indicated, for example, by the list parameter. For example, a resource corresponding to one sub-configuration can be determined by a resource set included in/associated with/corresponding to the CSI report configuration information. Optionally, the set corresponds to a resource set associated with/corresponding to the reporting configuration information (for example, NZP-CSI-RS-ResourceSet). Optionally, the resource set is in a CSI resource setting corresponding to the CSI report configuration information. Optionally, the CSI resource setting is used for channel measurement. For example, the CSI resource setting can be associated with/corresponding to a channel measurement resource parameter (for example, resourcesForChannelMeasurement) in the CSI report configuration information. The CSI resource setting is, for example, a CSI-ResourceConfig parameter. Optionally, the resource may be a reference signal resource. Optionally, the reference signal resource may be a reference signal. Optionally, the resource includes a CSI-RS resource or a CSI-IM resource. Optionally, a CSI-RS may be an NZP CSI-RS.

When the CSI report corresponds to one or more sub-configuration(s), a number of ports corresponding to the sub-configuration is unclear (especially when the maximum number of ports of the resource corresponding to the CSI report/the sub-configuration is determined). The method provided below can clarify a number of ports of a resource corresponding to the CSI report/the sub-configuration, avoiding inconsistency of understanding of the terminal device and the network device, and improving the reliability of the communication system. Optionally, the number of ports of the resource corresponding to the at least one (or each) sub-configuration of the plurality of first sub-configuration(s) or the second sub-configuration is determined based on an indication of the sub-configuration. Optionally, the number of ports of the resource corresponding to the at least one (or each) sub-configuration of the plurality of first sub-configuration(s) or the second sub-configuration is determined based on a number of ports of a resource in the resource set corresponding to the CSI report configuration information. Optionally, when the first condition is met, the number of ports of the resource corresponding to the sub-configuration is determined based on the indication of the sub-configuration. Optionally, when the second condition is met, the number of ports of the resource corresponding to the sub-configuration is determined based on the resource set corresponding to the CSI report configuration information.

For example, a number of ports of a resource corresponding to one sub-configuration can be determined based on a port parameter indicated in the sub-configuration. For example, a resource corresponding to one sub-configuration can be determined based on the number of ports of the resource in the resource set included in/associated with/corresponding to the CSI report configuration information. Here, the descriptions of the resource set can be found above. Optionally, a number of ports of a resource refers to a number of ports indicated by a port number parameter (for example, nrofPorts) corresponding to the resource. Optionally, the port number parameter is used to define the number (or total number) of ports of the corresponding resource.

The advantage of Embodiment 2 is that when one or more sub-configuration(s) are configured for CSI report, the limitation of a measurement resource of a CSI report corresponding to the one or more sub-configuration(s) (for example, a maximum number of configurable resources) is clarified, which ensures that a terminal device can handle the corresponding CSI report and improves the reliability of the communication system. In addition, clarifying the limitation of the measurement resource of the CSI report can help terminal device hardware to design pertinently and reduce hardware costs.

### Embodiment 3

A UE receives CSI report configuration information (for example, CSI-ReportConfig). Optionally, the CSI report configuration information is associated with/corresponds to/includes one or more first sub-configuration(s). Here, a sub-configuration may be referred to as sub-configuration information. Optionally, the first sub-configuration may be sub-configuration information of a CSI report. Here, the CSI report configuration information may correspond to one CSI report, or the CSI report configuration information may be used to refer to one CSI report. For example, the CSI report configuration information may be used to correspond to/refer to a first CSI report.

Optionally, a second sub-configuration includes one of the one or more first sub-configuration(s). Optionally, the second sub-configuration includes one of sub-configuration(s) in a subset of the one or more first sub-configuration(s). Here, for descriptions of the first sub-configuration and the second sub-configuration and the subset, refer to Embodiment 1.

Optionally, one of the one or more first sub-configuration(s) or the second sub-configuration may be referred to as a sub-configuration. Optionally, the sub-configuration may include/indicate/configure/be associated with at least one of the following:
A port parameter. Optionally, when a first condition is met, the sub-configuration may include/indicate/configure/be associated with the port parameter. For descriptions of the port parameter, refer to Embodiment 1.
A codebook parameter. Optionally, when the first condition is met, the sub-configuration may include/indicate/configure/be associated with the codebook parameter. For descriptions of the codebook parameter, refer to Embodiment 1.
A codebook type parameter. Optionally, when the first condition is met, the sub-configuration may include/indicate/configure/be associated with the codebook type parameter. For descriptions of the codebook type parameter, refer to Embodiment 1.
A rank restriction parameter. Optionally, when the first condition is met, the sub-configuration may include/indicate/configure/be associated with the rank restriction parameter. For descriptions of the rank restriction parameter, refer to Embodiment 1.
One or more resources. Optionally, when a second condition (or the first condition) is met, the sub-configuration may include/indicate/configure/be associated with the one or more resources. For descriptions of the one or more resources, refer to Embodiment 1.
A CQI table parameter. Optionally, when the second condition (or the first condition) is met, the sub-configuration may include/indicate/configure/be associated with the CQI table parameter. For descriptions of the CQI table parameter, refer to Embodiment 1.
A power parameter. Optionally, when the second condition (or the first condition) is met, the sub-configuration may include/indicate/configure/be associated with the power parameter. For descriptions of the power parameter, refer to Embodiment 1.
A frequency domain granularity parameter. For descriptions of the frequency domain granularity parameter, refer to Embodiment 1.

Optionally, the UE determines a CSI or report a CSI based on a plurality of first sub-configuration(s) or a second sub-configuration. Optionally, the CSI may be a CSI parameter. Optionally, determining the CSI parameter may be computing the CSI parameter. Optionally, determining the CSI parameter may be determining CSI feedback. Determining the CSI parameter can also be determining the report carrying the CSI parameter (that is, determining the CSI report). Optionally, the CSI parameter may be CSI feedback. The CSI parameter can also be a report carrying the CSI parameter (namely, the CSI report).

Optionally, the UE determines a CSI reference resource based on a plurality of first sub-configuration(s) or a second sub-configuration. Optionally, the UE determines a CSI reference resource of the CSI report (for example, the first CSI report) based on the plurality of first sub-configuration(s) or the second sub-configuration. Optionally, the UE determines a parameter n_{CSI}_{_{ref}} associated with the CSI reference resource of the CSI report (for example, the first CSI report) based on the plurality of first sub-configuration(s) or the second sub-configuration. Details of the parameter n_{CSI}_{_{ref}} is given below.

Optionally, the UE determines a CSI parameter (e.g., a CQI/PMI/RI) based on the CSI reference resource. Optionally, for one CSI report (for example, the first CSI report), the UE determines a CSI parameter (for example, a CQI/PMI/RI) corresponding to the CSI report based on the CSI reference resource. For example, if a CQI index/PMI/RI is configured to be reported, the UE derives the CQI index/PMI/RI based on the CSI reference resource.

Optionally, if there is no valid downlink slot for the CSI reference resource corresponding to a CSI Report Setting in a serving cell, CSI report is omitted for the serving cell (for example, CSI report in uplink slot n′).

Optionally, the UE derives the channel measurement and/or the interference measurement based on a reference signal not later than the CSI reference resource. Optionally, the UE derives the channel measurement and/or the interference measurement (for example, channel measurement and/or interference measurement for reporting a computed CSI value in the uplink slot n′) based on the reference signal not later than the CSI reference resource. Optionally, the channel measurement may be used to compute the L1-RSRP or the L1-SINR. Optionally, the interference measurement may be used to compute the L1-SINR. Optionally, the channel measurement and/or the interference measurement may be used to compute a CSI value. Optionally, a reference signal may be a reference signal occasion. Optionally, the reference signal may be a reference signal resource. Optionally, the reference signal may be at least one of the SSB, the CSI-RS, and the CSI-IM. Optionally, the CSI-RS may be an NZP CSI-RS. Optionally, the reference signal may be used for the channel measurement/or for the interference measurement. Optionally, the reference signal may be used for CSI acquisition. Optionally, the reference signal may be used for computing the L1-RSRP and/or for computing the L1-SINR.

For example, if a higher layer parameter of a time restriction for channel measurement (for example, timeRestrictionForChannelMeasurement) is set to be “not configured”, the UE derive the channel measurements for computing a CSI value reported in the uplink slot n′ based on only the NZP CSI-RS not later than the CSI reference resource associated with the CSI resource setting.

For example, if a higher layer parameter of a time restriction for channel measurement (for example, timeRestrictionForChannelMeasurement) in a CSI report configuration information (for example, CSI-ReportConfig) is set to be “configured”, the UE derive the channel measurements for computing a CSI value reported in the uplink slot n′ based on only the most recent, no later than the CSI reference resource, occasion of the NZP CSI-RS associated with the CSI resource setting.

For example, if a higher layer parameter of a time restriction for interference measurement (for example, timeRestrictionForInterferenceMeasurement) is set to be “not configured”, the UE derive the interference measurements for computing a CSI value reported in the uplink slot n′ based on only the CSI-IM and/or the NZP CSI-RS (for interference measurement) not later than the CSI reference resource associated with the CSI resource setting.

For example, if the higher layer parameter of the time restriction for interference measurement (for example, timeRestrictionForInterferenceMeasurement) is set to be “configured”, the UE shall derive the interference measurements for computing the CSI value reported in the uplink slot n′ based on the most recent, no later than the CSI reference resource, occasion of the CSI-IM and/or the NZP CSI-RS for interference measurement associated with the CSI resource setting.

A time domain definition/determining method of a CSI reference resource (for example, a CSI reference resource for a serving cell) is as follows.

In time domain, a CSI reference resource corresponding to one CSI report (for example, a CSI report in the uplink slot n′) is defined as a single downlink slot

$$n - {n}_{{CSI}_{ref}} - {K}_{offset} \cdot \frac{{2}^{{μ}_{DL}}}{{2}^{{μ}_{{K}_{offset}}}} .$$

Here, K_{offset} is a higher layer configuration parameter, and μ_{K}_{_{offset}} is a subcarrier interval configuration of a parameter K_{offset}. In a case of FRI (frequency range 1), a value of μ_{K}_{_{offset}} is 0. For example, K_{offset}=K_{cell,offset}−K_{UE,offset}, wherein K_{cell,offset} can be configured by a higher layer parameter (e.g., cellSpecifickoffset) and/or K_{UE,offset} can be indicated by a MAC-CE command (e.g., indicated by a MAC-CE indicating a difference Koffset). otherwise, if not provided, then K_{cell,offset}=0 or K_{UE,offset}=0. Here,

$$n = ⌊ {n}^{′} \cdot \frac{{2}^{{μ}_{DL}}}{{2}^{{μ}_{DL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋ ,$$

wherein μ_{DL} and μ_{UL} are respectively downlink and uplink subcarrier interval configurations, and (for a cell that transmits uplink and downlink), N_{slot, offset}^{CA} and μ_{offset} are determined based on the higher layer configuration parameter (e.g., ca-SlotOffset).

Taking a CSI report as a first CSI report as an example, when the first CSI report is a periodic CSI report or a semi-persistent CSI report, the definition/determination method of n_{CSI}_{_{ref}} is as follows:
When a number of resources corresponding to the first CSI report is less than or equal to a specific value (for example, the first CSI report corresponds to a single resource), n_{CSI}_{_{ref}} is the smallest value greater than or equal to 4·2^{μ}^{_{DL}}, such that n_{CSI}_{_{ref}} corresponds to a valid downlink slot. Optionally, the resource may be a CSI-RS/SSB resource. Optionally, the resource may be used for channel measurement.
When the number of resources corresponding to the first CSI report is greater than a specific value (for example, a single resource corresponding to the first CSI report), n_{CSI}_{_{ref}} is the smallest value greater than or equal to 5·2^{μ}^{_{DL}}, such that n_{CSI}_{_{ref}} corresponds to a valid downlink slot. Optionally, the resource may be a CSI-RS/SSB resource. Optionally, the resource may be used for channel measurement.

Taking a CSI report as a first CSI report as an example, when the first CSI report is an aperiodic CSI report, the definition/determination method of n_{CSI}_{_{ref}} is as follows:
If the UE is indicated by the DCI to report CSI in the same slot as a CSI request (for example, the CSI request is indicated/carried by the DCI), n_{CSI}_{_{ref}} is such that the reference resource is in the same valid downlink slot as the corresponding CSI request, otherwise n_{CSI}_{_{ref}} is the smallest value greater than or equal to

$$⌊ \frac{{Z}^{′}}{{N}_{symb}^{slot}} ⌋ ,$$

such that a slot n−n_{CSI}_{_{ref}} corresponds to a valid downlink slot. Optionally, for the descriptions/determining method of z′, refer to Embodiment 1. Here, N_{symb}^{slot} indicates/represents a number of symbols per slot.

Optionally, a slot in a cell (e.g., a serving cell) can be considered as a valid downlink slot if at least one of the following conditions is met:
The slot includes at least one higher layer configured downlink or flexible symbol.
The slot does not fall within a configured measurement gap. Optionally, the configured measurement gap is used for the UE.

Optionally, (for the definition/determining of n_{CSI}_{_{ref}},) that the number of resources corresponding to the first CSI report is less than or equal to a specific value means that a number of resources corresponding to the at least one (or each) sub-configuration of the plurality of first sub-configuration(s) or the second sub-configuration is less than or equal to the specific value (or corresponds to a single resource). Optionally, (for the definition/determining of n_{CSI}_{_{ref}},) that the number of resources corresponding to the first CSI report is less than or equal to a specific value means that when the first condition or the second condition is met, the number of resources corresponding to the at least one (or each) sub-configuration of the plurality of first sub-configuration(s) or the second sub-configuration is less than or equal to the specific value (or corresponds to a single resource).

Optionally, (for the definition/determining of n_{CSI}_{_{ref}},) that the number of resources corresponding to the first CSI report is greater than or equal to a specific value means that the number of resources corresponding to the at least one (or each) sub-configuration of the plurality of first sub-configuration(s) or the second sub-configuration is greater than or equal to the specific value (or corresponds to a single resource). Optionally, (for the definition/determining of n_{CSI}_{_{ref}}>) that the number of resources corresponding to the first CSI report is 1 means that when the first condition or the second condition is met, the number of resources corresponding to the at least one (or each) sub-configuration of the plurality of first sub-configuration(s) or the second sub-configuration is or is equal to the specific value (or corresponds to a single resource).

Optionally, the specific value may be predefined. For example, the specific value is one of 1, 2, 3, and 4. Optionally, the specific value may be based on a UE capability. For example, the specific value is indicated by a capability signalling reported by the UE. Optionally, the specific value may be indicated by a base station. For example, the specific value is indicated by at least one of RRC, a MAC-CE and a DCI signalling.

The advantage of this method is that a CSI reference resource can be determined based on a number of resources corresponding to at least one (or each) sub-configuration corresponding to one CSI report (for example, a related parameter n_{CSI}_{_{ref}} can be determined), and the method for determining the CSI reference resource of the CSI report in the case of corresponding to a plurality of sub-configuration(s) is clarified, which improves the reliability of the system.

When the CSI report corresponds to one or more sub-configuration(s), it is unclear which resources the sub-configuration(s) correspond to (especially when the CSI reference resource corresponding to the CSI report is determined). The method provided below can clarify a resource (or a number of corresponding resources) corresponding to the sub-configuration, avoiding inconsistency of understanding of the terminal device and the network device, and improving the reliability of the communication system. Optionally, the resource corresponding to the sub-configuration is determined based on an indication of the sub-configuration (for example, a parameter of the indication). Optionally, a resource corresponding to at least one (or each) sub-configuration of the plurality of first sub-configuration(s) or the second sub-configuration is determined based on a resource set corresponding to the CSI report configuration information. Optionally, when the first condition is met, that the sub-configuration corresponds to one resource is determined based on the resource set corresponding to the CSI report configuration information. Optionally, when the second condition is met, that the sub-configuration corresponds to one resource (or a single resource) is determined based on the indication of the sub-configuration (for example, the parameter of the indication).

For example, a resource corresponding to one sub-configuration can be determined based on one or more resources indicated in the sub-configuration. The one or more resources are indicated, for example, by the list parameter. For example, a resource corresponding to one sub-configuration can be determined by a resource set included in/associated with/corresponding to the CSI report configuration information. For example, a number of resources included in this resource set is 1. For example, a number of resources included in this resource set is greater than 1. Optionally, the set corresponds to a resource set associated with/corresponding to the CSI report configuration information (for example, NZP-CSI-RS-ResourceSet). Optionally, the resource set is in a CSI resource setting corresponding to the CSI report configuration information. Optionally, the CSI resource setting is used for channel measurement. For example, the CSI resource setting can be associated with/corresponding to a channel measurement resource parameter (for example, resourcesForChannelMeasurement) in the CSI report configuration information. The CSI resource setting is, for example, a CSI-ResourceConfig parameter. Optionally, the resource may be a reference signal resource. Optionally, the reference signal resource may be a reference signal. Optionally, the resource includes a CSI-RS resource or a CSI-IM resource. Optionally, the CSI-RS may be an NZP CSI-RS.

The advantage of Embodiment 3 is that when one or more sub-configuration(s) are configured for CSI report, the definition/determining method of a CSI reference resource of a CSI report corresponding to one or more sub-configuration(s) in time domain is clarified. The method can enable a terminal device to perform CSI measurement and/or CSI determining and/or CSI report based on a reference signal or a measurement resource not later than the CSI reference resource. This enables the terminal device to have enough time to process the corresponding reference signal measurement, and improves the reliability of the communication system. In addition, clarifying the definition/determining method of the CSI reference resource can help to design terminal device hardware in a targeted way and reduce hardware costs.

### Embodiment 4

Optionally, a UE receives CSI report configuration information (for example, CSI-ReportConfig). Optionally, the CSI report configuration information is associated with/corresponds to/includes one or more sub-configuration(s). For example, a number (or a total number) of the one or more sub-configuration(s) may be L (L≥1, or L≥2). For example, the CSI report configuration information may include a list of sub-configuration(s). For example, the CSI report configuration information may include L sub-configuration(s). For example, the list of sub-configuration(s) is provided by a higher layer parameter (for example, csi-ReportSubConfigList). Optionally, one/each sub-configuration (in the list of sub-configuration(s)) is identified by an identifier (ID) (for example, csi-ReportSubConfigID). For example, one/each sub-configuration can be provided with an ID (e.g., csi-ReportSubConfigID) by a higher layer parameter.

Optionally, the method described in this embodiment needs to meet the condition: “The UE is configured with a CSI report configuration information, which includes a list of sub-configuration(s) (for example, a list of sub-configuration(s) of the list provided by the higher layer parameter csi-ReportSubConfigList)”.

Optionally, the UE reports CSI corresponding to one or more sub-configuration(s). Optionally, the UE reports the CSI corresponding to the one or more sub-configuration(s) based on the higher layer parameter (e.g., a report quantity parameter reportQuantity) corresponding to the CSI report configuration information. Optionally, the one or more sub-configuration(s) may be/may include N (indicated/triggered) sub-configuration(s) among L sub-configuration(s), where 1≤N≤L. Optionally, the N sub-configuration(s) can be equivalently interchanged with “triggered sub-configuration(s)”, “indicated sub-configuration(s)” or “corresponding CSI reported sub-configuration”. In the following descriptions, “one sub-configuration/each sub-configuration” may mean “one sub-configuration/each sub-configuration in the N sub-configuration(s)” or “one sub-configuration/each sub-configuration in a list of sub-configuration(s) (for example, in the L sub-configuration(s))”.

The following describes how a parameter in the sub-configuration is configured.

Optionally, a codebook (configured by the CSI report)/a codebook (for example, a codebook type parameter codebookType) corresponding to the UE can be configured as a type I single-panel codebook (for example, the codebook type parameter codebookType is set to ‘typeI-SinglePanel’) or a type I multi-panel codebook (for example, the codebook type parameter codebookType is set to ‘typeI-MultiPanel’). For example, the UE expects the codebook type parameter codebookType to be set to a ‘typeI-SinglePanel’, or a ‘typeI-MultiPanel’. If the UE provides/reports/indicates the capability for supporting mixed codebook combination in a slot, one/each sub-configuration (corresponding codebook) may include (or, be configured with) codebook type parameter (codebookType) that is set to ‘typeI-SinglePanel’, or include (or, be configured with) codebook type parameter (codebookType) of ‘typeI-MultiPanel’.

Optionally, when the following tenth condition is met, a sub-configuration/each sub-configuration may include (or be configured with) an i2 subset restriction parameter of a type I single-panel codebook (typeI-SinglePanel-codebookSubsetRestriction-i2). Here, the tenth condition includes at least one of the following:
the UE is configured with a CSI report configuration information, which includes a list of sub-configuration(s) (for example, a list of sub-configuration(s) of the list provided by the higher layer parameter csi-ReportSubConfigList);
a PMI format indicator parameter corresponding to/configured for the CSI report configuration information is set as a ‘wideband PMI’ (pmi-FormatIndicator set to ‘widebandPMI’);
(this sub-configuration/each sub-configuration/CSI report configuration information) corresponds to wideband CSI;
the higher layer parameter (for example, a report quantity parameter reportQuantity) corresponding to/included in the CSI report configuration information is set to ‘cri-RI-i1-CQI’;
a configured (or included) codebook type parameter (of the sub-configuration/each sub-configuration/CSI report configuration information) is set to ‘typeI-SinglePanel’; and
the sub-configuration/each sub-configuration is configured with an antenna port subset, or the sub-configuration/each sub-configuration is configured with a port subset indicator parameter (port-subsetIndicator).

Optionally, one sub-configuration determines CSI corresponding to the sub-configuration based on an i2 subset restriction parameter of a type I single-panel codebook (configured for the sub-configuration). For example, a randomly selected precoder on which a CQI corresponding to one sub-configuration is based is determined based on the i2 subset restriction parameter of the type I single-panel codebook.

Optionally, if a sub-configuration (for example, a CSI report sub-configuration parameter csi-ReportSubConfig) is configured, for a corresponding CSI sub-report, a bitwidth of a CSI field of the CSI sub-report is determined based on a configuration in the CSI report sub-configuration parameter (when applicable).

Optionally, when the tenth condition is met, all bits in the i2 subset restriction parameter of the type I single-panel codebook are 1. Optionally, when the tenth condition is met, all bits in an i2 subset restriction parameter of a type I single-panel codebook in a codebook configuration parameter (CodebookConfig) corresponding to a CSI report are 1. Optionally, when the tenth condition is met, the UE determines/assumes/expects that all the bits in the i2 subset restriction parameter of the type I single-panel codebook (in the codebook configuration parameter corresponding to the CSI report) are 1. For example, a bit sequence formed by the i2 subset restriction parameter of the type I single-panel codebook is b15, . . . , b1, b0, wherein 0 is the least significant bit (LSB) and b15 is the most significant bit (MSB). For example, that all the bits in the i2 subset restriction parameter of the type I single-panel codebook are 1 means that b15, . . . , 1, b0 are all 1.

Optionally, when the following tenth condition is met, and one sub-configuration/each sub-configuration does not include (or is not configured with) the i2 subset restriction parameter of the type I single-panel codebook (typeI-SinglePanel-codebookSubsetRestriction-i2), the UE determines/assumes that all bits in the i2 subset restriction parameter of the type I single-panel codebook corresponding to the sub-configuration/each sub-configuration are 1. For example, a bit sequence formed by the i2 subset restriction parameter of the type I single-panel codebook is b15, . . . , b1, b0, wherein 0 is the least significant bit (LSB) and b15 is the most significant bit (MSB). For example, that all the bits in the i2 subset restriction parameter of the type I single-panel codebook are 1 means that b15, . . . , 1, b0 are all 1.

Optionally, when the following tenth condition is met, and one sub-configuration/each sub-configuration does not include (or is not configured with) the i2 subset restriction parameter of the type I single-panel codebook (typeI-SinglePanel-codebookSubsetRestriction-i2), a codebook index i2 corresponding to the sub-configuration/each sub-configuration has no restriction (or, the codebook index i2 corresponding to the sub-configuration/each sub-configuration does not correspond to precoding that is not allowed for CQI computation).

Embodiment 4 provides a configuration method/usage method of a higher layer parameter (for example, the i2 subset restriction parameter of the type I single-panel codebook), so that the parameter can be used in a CSI report configuration information including a list of sub-configuration(s), or a predefined behavior can be performed. Therefore, the behavior of CSI report is clarified and the performance of a communication system is improved.

### Embodiment 5

Optionally, a UE receives a CSI report configuration information (for example, CSI-ReportConfig). Optionally, the CSI report configuration information is associated with/corresponds to/includes one or more sub-configuration(s). For example, a number (or a total number) of the one or more sub-configuration(s) may be L (L>1, or L>2). For example, the CSI report configuration information may include a list of sub-configuration(s). For example, the CSI report configuration information may include L sub-configuration(s). For example, the list of sub-configuration(s) is provided by a higher layer parameter (for example, csi-ReportSubConfigList). Optionally, one/each sub-configuration (in the list of sub-configuration(s)) is identified by an identifier (ID) (for example, csi-ReportSubConfigID). For example, one/each sub-configuration can be provided with an ID (e.g., csi-ReportSubConfigID) by a higher layer parameter.

Optionally, the method described in this embodiment needs to meet the condition: “The UE is configured with a CSI report configuration information, which includes a list of sub-configuration(s) (for example, a list of sub-configuration(s) of the list provided by the higher layer parameter csi-ReportSubConfigList)”.

Optionally, the UE reports CSI corresponding to one or more sub-configuration(s). Optionally, the UE reports the CSI corresponding to the one or more sub-configuration(s) based on the higher layer parameter (e.g., a report quantity parameter reportQuantity) corresponding to the CSI report configuration information. Optionally, the one or more sub-configuration(s) may be/may include N (indicated/triggered) sub-configuration(s) among L sub-configuration(s), where 1<N<L. Optionally, the N sub-configuration(s) can be equivalently interchanged with “triggered sub-configuration(s)”, “indicated sub-configuration(s)” or “corresponding CSI reported sub-configuration”. In the following descriptions, “one sub-configuration/each sub-configuration” may mean “one sub-configuration/each sub-configuration in the N sub-configuration(s)” or “one sub-configuration/each sub-configuration in a list of sub-configuration(s) (for example, in the L sub-configuration(s))”.

The following describes how a parameter in the sub-configuration is configured.

Optionally, a codebook (configured by the CSI report)/a codebook (for example, a codebook type parameter codebookType) corresponding to the UE can be configured as a type I single-panel codebook (for example, the codebook type parameter codebookType is set to ‘typeI-SinglePanel’) or a type I multi-panel codebook (for example, the codebook type parameter codebookType is set to ‘typeI-MultiPanel’). For example, the UE expects the codebook type parameter codebookType to be set to ‘typeI-SinglePanel’, or ‘typeI-MultiPanel’. If the UE provides/reports/indicates the capability for supporting mixed codebook combination in a slot, one/each sub-configuration (corresponding codebook) may include (or, be configured with) a codebook type parameter (codebookType) set to ‘typeI-SinglePanel’ or ‘typeI-MultiPanel’.

Optionally, when the following eleventh condition is met, one sub-configuration/each sub-configuration may include (or be configured with) codebook mode parameter (codebookMode). Here, the eleventh condition includes at least one of the following:
the UE is configured with a CSI report configuration information, which includes a list of sub-configuration(s) (for example, a list of sub-configuration(s) of the list provided by the higher layer parameter csi-ReportSubConfigList);
the CSI report configuration information includes at least one sub-configuration with corresponding codebook type parameter being set to ‘typeI-SinglePanel’ and at least one sub-configuration with corresponding codebook type parameter being set to ‘typeI-MultiPanel’;
the CSI report configuration information contains (or is configured with) a mixed of sub-configuration(s) each corresponding to high layer parameter codebookType set to ‘typeI-SinglePanel’ and some other sub-configuration(s) each corresponding to high layer parameter codebookType set to ‘typeI-MultiPanel’; and
the sub-configuration/each sub-configuration is configured with an antenna port subset, or the sub-configuration/each sub-configuration is configured with a port subset indicator parameter (port-subsetIndicator).

Optionally, a sub-configuration determines CSI corresponding to the sub-configuration based on the codebook mode parameter (configured for the sub-configuration).

Optionally, if a sub-configuration (for example, CSI report sub-configuration parameter csi-ReportSubConfig) is configured, for a corresponding CSI sub-report, the bitwidth of a CSI field of the CSI sub-report is determined based on the configuration(s) in the CSI report sub-configuration parameter (when applicable).

Optionally, when the eleventh condition is met, and one sub-configuration/each sub-configuration does not include (or is not configured with) the codebook mode parameter (codebookMode), the UE determines/assumes that the codebook mode parameter corresponding to the sub-configuration/each sub-configuration is equal to 1, or that the codebook mode parameter corresponding to the sub-configuration/each sub-configuration is equal to 2.

Embodiment 5 provides a configuration method/usage method of a higher layer parameter (for example, the codebook mode parameter), so that the parameter can be used in a CSI report configuration information including a list of sub-configuration(s), or a predefined behavior can be performed. Therefore, the behavior of CSI report is clarified and the performance of a communication system is improved.

### Embodiment 6

Optionally, a UE receives a CSI report configuration information (for example, CSI-ReportConfig). Optionally, the CSI report configuration information is associated with/corresponds to/includes one or more sub-configuration(s). For example, a number (or a total number) of the one or more sub-configuration(s) may be L (L>1, or L>2). For example, the CSI report configuration information may include a list of sub-configuration(s). For example, the CSI report configuration information may include L sub-configuration(s). For example, the list of sub-configuration(s) is provided by a higher layer parameter (for example, csi-ReportSubConfigList). Optionally, one/each sub-configuration (in the list of sub-configuration(s)) is identified by an identifier (ID) (for example, csi-ReportSubConfigID). For example, one/each sub-configuration can be provided with an ID (e.g., csi-ReportSubConfigID) by a higher layer parameter.

Optionally, the method described in this embodiment needs to meet the condition: “The UE is configured with a CSI report configuration information, which includes a list of sub-configuration(s) (for example, a list of sub-configuration(s) of the list provided by the higher layer parameter csi-ReportSubConfigList)”.

Optionally, the UE reports CSI corresponding to one or more sub-configuration(s). Optionally, the UE reports the CSI corresponding to the one or more sub-configuration(s) based on the higher layer parameter (e.g., a report quantity parameter reportQuantity) corresponding to the CSI report configuration information. Optionally, the one or more sub-configuration(s) may be/may include N (indicated/triggered) sub-configuration(s) among L sub-configuration(s), where 1≤N≤L. Optionally, the N sub-configuration(s) can be equivalently interchanged with “triggered sub-configuration(s)”, “indicated sub-configuration(s)” or “corresponding CSI reported sub-configuration”. In the following descriptions, “one sub-configuration/each sub-configuration” may mean “one sub-configuration/each sub-configuration in the N sub-configuration(s)” or “one sub-configuration/each sub-configuration in a list of sub-configuration(s) (for example, in the L sub-configuration(s))”.

The following describes how a parameter in the sub-configuration is configured.

Optionally, a codebook (configured by the CSI report)/a codebook (for example, a codebook type parameter codebookType) corresponding to the UE can be configured as a type I single-panel codebook (for example, the codebook type parameter codebookType is set to ‘typeI-SinglePanel’) or a type I multi-panel codebook (for example, the codebook type parameter codebookType is set to ‘typeI-MultiPanel’). For example, the UE expects the codebook type parameter codebookType to be set to a “type I single-panel codebook” (‘typeI-SinglePanel’), or a “type I multi-panel codebook” (‘typeI-MultiPanel’). If the UE provides/reports/indicates the ability to support mixed codebook combination in a slot, one/each sub-configuration (corresponding codebook) may include (or, be configured with) a codebook type parameter (codebookType) that is set to ‘typeI-SinglePanel’, or include (or, be configured with) a codebook type parameter (codebookType) of ‘typeI-MultiPanel’.

Optionally, one/each sub-configuration may be configured with a port subset (for example, an antenna port subset). For example, one/each sub-configuration can be configured with a port subset based on a higher layer parameter (for example, port-subsetIndicator). Optionally, the higher layer parameter includes/configures/indicates a bitmap (e.g., a bit sequence). The bit sequence includes Pm (Pm≥1) bits, wherein Pm refers to a number of CSI-RS resource ports configured based on a higher layer parameter (e.g., nrofPorts). Here, a CSI-RS resource refers to s CSI-RS resource in the first resource set. Optionally, the bit sequence can be p0, p1 . . . , pPm−1, wherein p0 refers to the most significant bit (MSB), and pPm−1 refers to the least significant bit (LSB). Bit pi corresponds to an antenna port 3000+i. Optionally, corresponding antenna ports indicated/represented by a bit value 0 (in a higher layer parameter port-subsetIndicator) are disabled for this sub-configuration. Optionally, corresponding antenna ports indicated/represented by a bit value 0 (in a higher layer parameter port-subsetIndicator) are enabled for this sub-configuration, and these (enabled) ports are subordinate to the antenna port subset of the sub-configuration. For the computation/derivation of the PMI, antenna ports corresponding to all bits with value of 1 in the higher layer parameter (e.g., port-subsetIndicator) are mapped to consecutive (CSI-RS) antenna ports starting at an antenna port 3000 in increasing order of the bit position. Optionally, the antenna port subset (or an antenna port parameter) can be used to determine CSI of a resource (or a resource subset or a resource subset corresponding to a third parameter) corresponding to the corresponding sub-configuration.

Optionally, if one/each sub-configuration is configured with an antenna port subset, the sub-configuration may be limited by a configured rank indicator (RI) (e.g., a parameter for limiting the RI). Optionally, a higher layer parameter (e.g., reportQuantity) in a CSI report configuration information (optionally, the CSI report configuration information is used for reporting the CQI) corresponding to/associated with one/each sub-configuration is set to ‘cri-RI-PMI-CQI’ or ‘cri-RI-L1-PMI-CQI’, and/or, a corresponding/associated CSI-RS resource group (used for channel measurement) is configured with two groups (for example, when NABC=2) and Ncom resource pairs, a CRI of a report corresponding to/associated with this sub-configuration corresponds to one (or an entry) of the Ncom resource pairs, and/or a combination of ranks of the report corresponding to/associated with this sub-configuration is {v₁, v₂}. Optionally, v₁ corresponds to/indicates/refers to a value/number of ranks (of a report corresponding to the group 1); v₂ corresponds to/indicates/refers to a value/number of ranks (of a report corresponding to the group 2). Optionally, v₁≥1 and v₂≥1. The rank combination can be one of {1, 1}, {1, 2}, {2, 1}, and {2, 2}. Optionally, two RIs can be reported by a joint RI index. The joint RI index corresponds to one of the rank combinations {1,1}, {1,2}, {2,1} and {2,2}. Optionally, the RI restriction parameter can be used to determine CSI of a resource (or a resource subset or a resource subset corresponding to a third parameter) corresponding to the corresponding sub-configuration.

Optionally, if one/each sub-configuration is configured with an antenna port subset, the sub-configuration may be configured to determine at least one of N1 and N2 (and/or codebook subset restrictions), a parameter for determining N1, N2, and Ng (and/or the codebook subset restrictions), and parameters of Ng. For example, when a codebook type (corresponding to the sub-configuration or the CSI report configuration information) is set to a type I single-panel codebook (for example, if the higher layer parameter codebookType is set to ‘typeI-SinglePanel’), the sub-configuration can be configured with a higher layer parameter n1-n2 (if a number of antenna port subsets is greater than 2). For example, when the codebook type is set to a type I multi-panel codebook (for example, if the higher layer parameter codebookType is set to ‘typeI-MultiPanel’), the sub-configuration can be configured with a higher layer parameter ng-n1-n2 (if the number of antenna port subsets is greater than 2). For example, the sub-configuration can be configured with a higher layer parameter twoTX-CodebookSubsetRestriction (if the number of antenna port subsets is equal to 2). Optionally, at least one of the parameters for determining N1 and N2, the parameter for determining N1, N2, and Ng, and the parameter for determining Ng can be used to determine CSI of a resource (or a resource subset or a resource subset corresponding to a third parameter) corresponding to the corresponding sub-configuration.

Optionally, one/each sub-configuration may be configured with a power parameter (e.g., a parameter for indicating a power offset). Optionally, the power parameter is used to indicate/determine a power offset (of a CSI-RS resource), wherein the power offset refers to a (EPRE) power offset of an additional PDSCH relative to a CSI-RS based on the higher layer parameter corresponding to the CSI-RS resource (for example, powerControlOffset). Optionally, the power parameter can be used to determine CSI of a resource (or a resource subset or a resource subset corresponding to a third parameter) corresponding to the corresponding sub-configuration.

The following describes a usage method of a parameter in the sub-configuration.

Optionally, CSI of a sub-configuration is determined according to the parameters configured in the sub-configuration (when applicable); otherwise, according to the parameters configured in codebook configuration parameters for the CSI report configuration information.

Optionally, if a parameter is configured in a codebook configuration parameter in the CSI report configuration information, and/or the parameter (or a parameter corresponding to the parameter, or a parameter with the same type as the parameter) is not configured in a sub-configuration, then the parameter is applicable to (CSI determining of, or CSI reported by) the sub-configuration; otherwise (for example, if a parameter is configured in the codebook configuration parameter in the CSI report configuration information, and/or the parameter (or a parameter corresponding to the parameter, or a parameter with the same type as the parameter) is configured in a sub-configuration), then the parameter configured in the sub-configuration is applicable to (CSI determining of, or the CSI reported by) the sub-configuration.

Optionally, if a parameter is configured in a codebook configuration parameter in the CSI report configuration information, and/or the parameter (or a parameter corresponding to the parameter, or a parameter with the same type as the parameter) is not configured in a sub-configuration, then the parameter is applicable to (CSI determining of, or CSI reported by) the sub-configuration; otherwise (for example, if a parameter is configured in the codebook configuration parameter in the CSI report configuration information, and/or the parameter (or a parameter corresponding to the parameter, or a parameter with the same type as the parameter) is configured in a sub-configuration), then the parameter configured in the sub-configuration is applicable to (CSI determining of, or the CSI reported by) the sub-configuration.

Optionally, if a parameter is configured in a codebook configuration parameter in the CSI report configuration information, and/or the parameter (or a parameter corresponding to the parameter, or a parameter with the same type as the parameter) is not configured in a sub-configuration, then CSI of the sub-configuration (or CSI of a report of the sub-configuration) is determined based on the parameter; otherwise (for example, if a parameter is configured in the codebook configuration parameter in the CSI report configuration information, and/or the parameter (or a parameter corresponding to the parameter, or a parameter with the same type as the parameter) is configured in a sub-configuration), then the CSI of the sub-configuration (or the CSI of the report of the sub-configuration) is determined based on the parameter configured in the sub-configuration.

Embodiment 6 provides a configuration method/usage method of a higher layer parameter, so that the sub-configuration can determine corresponding CSI based on a correct parameter. Therefore, the behavior of CSI reporting is clarified and the performance of a communication system is improved.

### Embodiment 7

For a CSI report configuration information (CSI-ReportConfig), when a UE is configured with cell discontinuous transmission DTX and/or the cell DTX is activated and/or DRX is configured, after at least one of the CSI report (re) configuration, serving cell activation, BWP change, or activation of SP-CSI, the UE reports a CSI report only after receiving at least one CSI-RS transmission occasion (and/or one CSI-RS and/or CSI-IM resource transmission occasion for interference measurement) no later than the CSI reference resource and in the active period (or in the same active period) of cell DTX and/or in a DRX active time (and/or in the same DRX active time) and drops the report otherwise. Optionally, the one CSI-RS transmission occasion indicates/includes one CSI-RS transmission occasion for each periodic CSI-RS resource or each semi-persistent CSI-RS resource (in a corresponding CSI-RS resource set or in a corresponding resource pair) for channel measurement (and/or interference measurement). Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource. Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource in the corresponding resource set. Optionally, the codebook type parameter (codebookType) configured for the CSI report configuration information is set to ‘type II joint transmission and port selection’ (‘typeII-CJT-r18’ or ‘typeII-CJT-PortSelection-r18’), and/or the reporting quantity parameter associated with the CSI report configuration information at least include a ‘rank indicator’, and/or the reporting quantity parameter associated with the CSI report configuration information is set to ‘cri-RI-PMI-CQI’. Optionally, a CSI-RS resource set for channel measurement corresponding to the CSI report configuration information is configured with two resource groups and N resource pairs. Here, N≥1.

In this embodiment, the DRX can be either UE DRX or C-DRX (connected mode DRX).

Embodiment 7 provides a method for determining whether CSI is reported, so that a CSI report can be correctly transmitted or is not transmitted when cell DTX/DRX is configured and/or DRX is configured and/or a specific condition is met. Therefore, the behavior of CSI report is clarified and the performance of a communication system is improved.

### Embodiment 8

For a CSI report configuration information (CSI-ReportConfig), when a UE is configured with cell discontinuous transmission (DTX) and/or the cell DTX is activated and/or DRX is configured, after at least one of the CSI report (re) configuration, serving cell activation, BWP change, or activation of SP-CSI, the UE reports a CSI report only if receiving at least one or more CSI-RS transmission occasion(s) (and/or one CSI-RS and/or CSI-IM resource transmission occasion for interference measurement) no later than the CSI reference resource and in the active period (or in the same active period) of cell DTX and/or in a DRX active time (and/or in the same DRX active time) and drops the report otherwise. Optionally, the one or more CSI-RS transmission occasion(s) refer to/include at least one of the following:
Kₚ semi-persistent consecutive CSI-RS transmission occasion(s) for each CSI-RS resource (in the corresponding CSI-RS Resource Set) for channel measurement (and/or interference measurement). Optionally, Kₚ is indicated by a UE capability (or a UE capability signalling). Optionally, a range of Kₚ is 1, 2, and 4, or Kₚ∈{1, 2, 4};
Kₚ periodic consecutive CSI-RS transmission occasion(s) for each CSI-RS resource (in the corresponding CSI-RS Resource Set) for channel measurement (and/or interference measurement). Optionally, Kₚ is indicated by a UE capability (or a UE capability signalling). Optionally, a range of Kₚ is 1, 2, and 4, or Kₚ∈{1, 2, 4}.

Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource. Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource in the corresponding resource set. Optionally, the codebook type parameter (codebookType) configured for the CSI report configuration information is set to ‘typeII-Doppler-r18’ or ‘typeII-Doppler-PortSelection-r18’, and/or the reporting quantity parameter associated with the CSI report configuration information at least include a ‘RI’, and/or the reporting quantity parameter associated with the CSI report configuration information is set to ‘cri-RI-PMI-CQI’.

In this embodiment, the DRX can be either UE DRX or C-DRX (connected mode DRX).

Embodiment 8 provides a method for determining whether CSI is reported, so that a CSI report can be correctly transmitted or is not transmitted when cell DTX/DRX is configured and/or DRX is configured and/or a specific condition is met. Therefore, the behavior of CSI report is clarified and the performance of a communication system is improved.

### Embodiment 9

For a CSI report configuration information, a UE that is configured with cell DTX and/or is configured with DRX and/or for which the cell DTX is activated reports a CSI report only if receiving at least one CSI-RS transmission occasion (and/or one CSI-RS and/or CSI-IM resource transmission occasion for interference measurement) no later than the CSI reference resource and in the active period (or in the same active period) of cell DTX and/or in a DRX active time (and/or in the same DRX active time), and the UE configured with cell DTX drops the report otherwise.

Optionally, the one CSI-RS transmission occasion indicates/includes one CSI-RS transmission occasion for each periodic CSI-RS resource or each semi-persistent CSI-RS resource (in a corresponding CSI-RS resource set or in a corresponding resource pair) for channel measurement (and/or interference measurement). Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource. Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource in the corresponding resource set. Optionally, the codebook type parameter (codebookType) configured for the CSI report configuration information is set to ‘type II joint transmission and port selection’ (‘typeII-CJT-r18’ or ‘typeII-CJT-PortSelection-r18’), and/or the reporting quantity parameter associated with the CSI report configuration information at least include a ‘rank indicator’, and/or the reporting quantity parameter associated with the CSI report configuration information is set to ‘cri-RI-PMI-CQI’. Optionally, a CSI-RS resource set for channel measurement corresponding to the CSI report configuration information is configured with two resource groups and N resource pairs. Here, N≥1.

In this embodiment, the DRX can be either UE DRX or C-DRX (connected mode DRX).

Embodiment 9 provides a method for determining whether CSI is reported, so that a CSI report can be correctly transmitted or is not transmitted when cell DTX/DRX is configured and/or DRX is configured and/or a specific condition is met. Therefore, the behavior of CSI report is clarified and the performance of a communication system is improved.

### Embodiment 10

For a CSI report configuration information, a UE that is configured with cell DTX and/or is configured with DRX and/or for which the cell DTX is activated reports a CSI report only if receiving at least one CSI-RS transmission occasion (and/or one CSI-RS and/or CSI-IM resource transmission occasion for interference measurement) no later than the CSI reference resource and in the active period (or in the same active period) of cell DTX and/or in a DRX active time (and/or in the same DRX active time), and the UE configured with cell DTX drops the report otherwise. Optionally, the one or more CSI-RS transmission occasion(s) refer to/include at least one of the following:
Kₚ semi-persistent consecutive CSI-RS transmission occasion(s) for each CSI-RS resource (in the corresponding CSI-RS Resource Set) for channel measurement (and/or interference measurement). Optionally, Kₚ is indicated by a UE capability (or a UE capability signalling). Optionally, a range of Kₚ is 1, 2, and 4, or Kₚ∈{1, 2, 4};
Kₚ periodic consecutive CSI-RS transmission occasion(s) for each CSI-RS resource (in the corresponding CSI-RS Resource Set) for channel measurement (and/or interference measurement). Optionally, Kₚ is indicated by a UE capability (or a UE capability signalling). Optionally, a range of Kₚ is 1, 2, and 4, or Kₚ∈{1, 2, 4}.

Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource. Optionally, one CSI-RS and/or CSI-IM resource transmission occasion includes/indicates one CSI-RS and/or CSI-IM resource transmission occasion for the (semi-persistent or periodic) CSI-RS and/or CSI-IM resource in the corresponding resource set. Optionally, the codebook type parameter (codebookType) configured for the CSI report configuration information is set to ‘typeII-Doppler-r18’ or ‘typeII-Doppler-PortSelection-r18’, and/or the reporting quantity parameter associated with the CSI report configuration information at least include a ‘RI’, and/or the reporting quantity parameter associated with the CSI report configuration information is set to ‘cri-RI-PMI-CQI’.

In this embodiment, the DRX can be either UE DRX or C-DRX (connected mode DRX).

Embodiment 10 provides a method for determining whether CSI is reported, so that a CSI report can be correctly transmitted or is not transmitted when cell DTX/DRX is configured and/or DRX is configured and/or a specific condition is met. Therefore, the behavior of CSI reporting is clarified and the performance of a communication system is improved.

FIG. 5 illustrates a method 500 performed by a base station according to an embodiment of the disclosure. The method 500 includes: at 501, the base station transmits CSI report configuration information to a user equipment; and at 502, the base station receives a CSI report determined based on the configuration information for CSI report. Optionally, the base station may receive a CSI computation delay parameter of the CSI report corresponding to the configuration information for CSI report before receiving the CSI report determined based on the configuration information for CSI reporting from the user equipment.

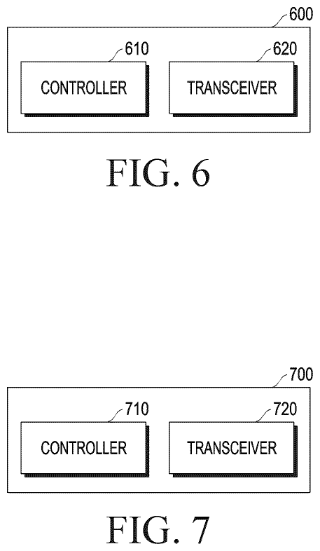

FIG. 6 illustrates a structure 600 of a user equipment according to various embodiments of the disclosure. As shown in FIG. 6, the user equipment 600 includes a controller 610 and a transceiver 620, wherein the controller 610 is configured to perform various methods disclosed herein and performed by the user equipment, and the transceiver 620 is configured to transmit and receive channels or signals.

FIG. 7 illustrates a structure 700 of a base station according to various embodiments of the disclosure. As shown in FIG. 7, the network device 700 includes a controller 710 and a transceiver 720, wherein the controller 710 is configured to perform various methods disclosed herein and performed by the network device, and the transceiver 720 is configured to transmit and receive channels or signals.

In this application, a “reference signal” can be equivalently replaced with a “reference signal resource”. In this application, a “CSI parameter” can be equivalently replaced with “CSI” (that is, in this invention, the CSI is described by taking the CSI parameter as an example). In this application, “if reported” can be equivalently replaced with “if existing” or “if applicable” or “if necessary”. In addition, a “CSI computation delay parameter” can be equivalently replaced with a “CSI computation delay requirement”, and “configuration information for CSI report (for example, csi-ReportConfig)” can be interchanged with a “CSI report configuration” or “CSI report configuration information” or a “CSI report setting”.

In this application, a resource corresponding to a sub-configuration (for example, a CSI-RS resource and a CSI-IM resource) can be understood as a resource referred by the sub-configuration. A resource corresponding to a first sub-configuration (or a plurality of first sub-configuration(s)) can be understood as a resource referred by the first sub-configuration (or the plurality of first sub-configuration(s)). A resource corresponding to a second sub-configuration can be understood as a resource referred by the second sub-configuration.

In order to enhance scheduling efficiency of a 5G wireless communication system, a base station needs to obtain channel state information (CSI) for scheduling based on the CSI fed back by a terminal device. However, how to further enhance performance related to a CSI report is a problem to be solved.

An aspect of the disclosure provides a method performed by a user equipment (UE) in a wireless communication system. The method includes: receiving a channel state information (CSI) report configuration information, wherein the CSI report configuration information includes a plurality of first sub-configurations; receiving downlink control information (DCI), wherein the DCI triggers one or more CSI reports; and determining a first CSI report included in the one or more CSI reports based on a second sub-configuration, wherein the second sub-configuration includes at least one of the plurality of first sub-configurations; wherein a CSI computation delay parameter corresponding to the first CSI report is a parameter with the largest value among CSI computation delay parameters corresponding to each first sub-configuration in the second sub-configuration, or when a condition A is met, a value of the CSI computation delay parameter corresponding to the first CSI report is a first parameter value; wherein the condition A includes at least one of the following: each first sub-configuration in the second sub-configuration corresponds to a single-panel codebook or does not report a precoding matrix indicator (PMI) parameter; each first sub-configuration in the second sub-configuration corresponds to a single resource; a number of ports of a resource corresponding to each first sub-configuration in the second sub-configuration is less than or equal to 4; each first sub-configuration in the second sub-configuration has a channel state information reference signal (CSI-RS) resource indicator (CRI) report; each first sub-configuration in the second sub-configuration corresponds to a wideband frequency domain granularity; or a number of the first sub-configuration(s) in the second sub-configuration is less than or equal to a specific value indicated by a base station.

In an example, the method further includes: when at least one of the following conditions is met, the first CSI report is reported, and a measurement resource corresponding to the first CSI report include a measurement resource that corresponds to each first sub-configuration in the second sub-configuration: a time unit carrying the one or more CSI reports is not later than a first time unit, wherein the first time unit is determined based on a time unit at which a physical downlink control channel (PDCCH) corresponding to the DCI is located and the CSI computation delay parameter corresponding to each CSI report in the one or more CSI reports; or a time unit carrying the first CSI report is not later than a second time unit, wherein the second time unit is determined based on a time unit of the measurement resource corresponding to the first CSI report and the CSI computation delay parameter corresponding to the first CSI report.

Another aspect of the disclosure provides a method performed by a base station in a wireless communication system. The method includes: transmitting a channel state information (CSI) report configuration information, wherein the CSI report configuration information includes a plurality of first sub-configurations; transmitting downlink control information (DCI), wherein the DCI triggers one or more CSI reports; and receiving a first CSI report, wherein the first CSI report is included in the one or more CSI reports and is determined based on a second sub-configuration, wherein the second sub-configuration includes at least one of the plurality of first sub-configurations; wherein a CSI computation delay parameter corresponding to the first CSI report is a parameter with the largest value among CSI computation delay parameters corresponding to each first sub-configuration in the second sub-configuration, or when a condition A is met, a value of the CSI computation delay parameter corresponding to the first CSI report is a first parameter value; wherein the condition A includes at least one of the following: each first sub-configuration in the second sub-configuration corresponds to a single-panel codebook or does not report a precoding matrix indicator (PMI) parameter; each first sub-configuration in the second sub-configuration corresponds to a single resource; a number of ports of a resource corresponding to each first sub-configuration in the second sub-configuration is less than or equal to 4; each first sub-configuration in the second sub-configuration has a channel state information reference signal (CSI-RS) resource indicator CRI report; each first sub-configuration in the second sub-configuration corresponds to a wideband frequency domain granularity; or a number of the first sub-configuration(s) in the second sub-configuration is less than or equal to a specific value indicated by the base station.

In an example, the measurement resource corresponding to each first sub-configuration in the second sub-configuration is determined based on at least one of the following: a parameter that is included in each first sub-configuration in the second sub-configuration and that is used to indicate one or more resources for channel measurement of the corresponding first sub-configuration; or a measurement resource set corresponding to the CSI report configuration information.

In an example, the method further includes: when a condition B is met, the value of the CSI computation delay parameter is a second parameter value, wherein the condition B includes at least one of the following: at least one first sub-configuration in the second sub-configuration corresponds to a multi-panel; at least one first sub-configuration in the second sub-configuration corresponds to a plurality of resources; a number of ports of a resource corresponding to at least one first sub-configuration in the second sub-configuration is greater than 4; at least one first sub-configuration in the second sub-configuration has the channel state information reference signal (CSI-RS) resource indicator (CRI) report; at least one first sub-configuration in the second sub-configuration corresponds to a sub-band frequency domain granularity; or the number of the first sub-configuration(s) in the second sub-configuration is greater than or equal to a specific value indicated by the base station.

In an example, that each first sub-configuration in the second sub-configuration corresponds to the single-panel codebook or does not report the precoding matrix indicator (PMI) parameter is determined based on at least one of the following: a parameter that is included in each first sub-configuration in the second sub-configuration and that is used to indicate a codebook type of the corresponding first sub-configuration; or a codebook type corresponding to the CSI report configuration information.

In an example, that each first sub-configuration in the second sub-configuration corresponds to the single resource is determined based on at least one of the following: a parameter that is included in each first sub-configuration in the second sub-configuration and that is used to indicate one or more resources for channel measurement of the corresponding first sub-configuration; or a resource set corresponding to the CSI report configuration information.

In an example, the number of the ports of the resource corresponding to each first sub-configuration in the second sub-configuration is determined based on at least one of the following: a parameter that is included in each first sub-configuration in the second sub-configuration and that is used to indicate a port subset of CSI-RS resources for channel measurement of the corresponding first sub-configuration; or a number of ports of a resource in a resource set corresponding to the CSI report configuration information.

In an example, that the at least one first sub-configuration in the second sub-configuration corresponds to the multi-panel is determined based on at least one of the following: a parameter that is included in the at least one first sub-configuration in the second sub-configuration and that is used to indicate a codebook type of the corresponding first sub-configuration; or a codebook type corresponding to the CSI report configuration information.

In an example, that the at least one first sub-configuration in the second sub-configuration corresponds to the plurality of resources is determined based on at least one of the following: a parameter that is included in the at least one first sub-configuration in the second sub-configuration and that is used to indicate one or more resources for channel measurement of the corresponding first sub-configuration; or a resource set corresponding to the CSI report configuration information.

In an example, the number of the ports of the resource corresponding to the at least one first sub-configuration in the second sub-configuration is determined based on at least one of the following: a parameter that is included in the at least one first sub-configuration in the second sub-configuration and that is used to indicate a port subset of CSI-RS resources for channel measurement of the corresponding first sub-configuration; or a number of ports of a resource in a resource set corresponding to the CSI report configuration information.

In an example, a maximum number of the ports of the resource corresponding to each first sub-configuration in the second sub-configuration is determined based on a number of the resources corresponding to each first sub-configuration in the second sub-configuration.

In an example, the number of the resources corresponding to each first sub-configuration in the second sub-configuration is a maximum value of the number of the resources corresponding to each first sub-configuration in the second sub-configuration.

In an example, when the number of the resources corresponding to each first sub-configuration in the second sub-configuration is 1, the maximum number of the ports is 32; and/or when the number of the resources corresponding to each first sub-configuration in the second sub-configuration is less than or equal to 2, the maximum number of the ports is 16; and/or when the number of the resources corresponding to each first sub-configuration in the second sub-configuration is greater than 2 and less than or equal to 8, the maximum number of the ports is 8.

In an example, the number of the ports of the resource corresponding to each first sub-configuration in the second sub-configuration is determined based on at least one of the following: a parameter that is included in each first sub-configuration in the second sub-configuration and that is used to indicate a port subset of CSI-RS resources for channel measurement of the corresponding first sub-configuration; or a number of ports of a resource in a resource set corresponding to the CSI report configuration information.

In an example, a CSI reference resource corresponding to the first CSI report is determined based on the resource that corresponds to each first sub-configuration in the second sub-configuration and that corresponds to the first CSI report.

In an example, the measurement resource corresponding to each first sub-configuration in the second sub-configuration is determined based on at least one of the following: a parameter that is included in each first sub-configuration in the second sub-configuration and that is used to indicate one or more resources for channel measurement of the corresponding first sub-configuration; or a measurement resource set corresponding to the first CSI report.

In an example, the second sub-configuration is used to trigger a signalling indication of a CSI report corresponding to the CSI report configuration information.

Another aspect of the present disclosure provides a user equipment, including: a transceiver and a controller coupled with the transceiver and configured to perform the method which can be performed by the user equipment.

Another aspect of the disclosure provides a base station including a transceiver; and a controller coupled with the transceiver and configured to perform the method which can be performed by the controller.

The method provided by this application can improve performance of CSI, and further improve scheduling efficiency of a communication system.

Furthermore, “at least one item/at least one” described in this disclosure includes any and/or all possible combinations of listed items, and various embodiments and examples in the embodiments described in this disclosure can be changed and combined in any suitable form, and “/” described in this disclosure means “or”.

The various illustrative logic blocks, modules, and circuits described in this disclosure may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. An exemplary storage medium is coupled to a processor to enable the processor to read and write information from/to the storage medium. In an alternative, the storage medium may be integrated into the processor. The processor and the storage medium may reside in an ASIC. The ASIC may reside in a user equipment. In an alternative, the processor and the storage medium may reside in a user equipment as discrete components.

In one or more exemplary designs, the functions may be implemented in hardware, software, firmware, or any combination thereof. If implemented in software, each function may be stored as one or more instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The descriptions set forth herein, taken in conjunction with the drawings, describe example configurations, methods and apparatuses, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technologies. However, these technologies may be practiced without these specific details. In some cases, well-known structures and devices are shown in a block diagram form to avoid obscuring the concepts of the described examples.

Although this specification contains many specific implementation details, these should not be interpreted as limitations on any invention or the claimed protection scope, but as descriptions of specific features of specific embodiments of specific inventions. Some features described in this specification in the context of separate embodiments can also be combined in a single embodiment. On the contrary, various features described in the context of a single embodiment can also be implemented separately in a plurality of embodiments or in any suitable sub-combination. Furthermore, although features may be described above as functioning in some combinations, and even initially claimed as such, in some cases, one or more features from the claimed combinations may be deleted from the combinations, and the claimed combinations may be directed to a sub-combination or a variation of a sub-combination.

It should be understood that a specific order or hierarchy of steps in the method of this disclosure is illustrative of an exemplary process. Based on design preferences, it can be understood that the specific order or hierarchy of the steps in the method can be rearranged to achieve the functions and effect disclosed in this disclosure. The appended method claims present elements of various steps in an example order, and are not meant to be limited to the particular order or hierarchy presented, unless otherwise stated. Furthermore, although elements may be described or claimed in the singular, the plural is also contemplated unless the limitation on the singular is explicitly stated. Therefore, this disclosure is not limited to the illustrated examples, and any apparatus for performing the functions described herein are included in various aspects of this disclosure.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, channel state information (CSI) report configuration information including a list of sub-configurations; and
transmitting, to the base station, a first CSI report for at least one sub-configuration associated with the list of sub-configurations.

2. The method of claim 1, further comprising:
receiving, from the base station, a report quantity configuration corresponding to the CSI report configuration,
wherein the first CSI report is determined based on the report quantity configuration, and
wherein the at least one sub-configuration included in the sub-configurations is configured with a codebook mode parameter, in case that the at least one sub-configuration is configured with an antenna port subset, that the at least one sub-configuration is configured with a port subset indicator, and that the CSI report configuration information includes sub-configurations of a mixed codebook type.

3. The method of claim 1, further comprising:
receiving, from the base station, a report quantity configuration corresponding to the CSI report configuration,
wherein the first CSI report is determined based on the report quantity configuration, and
wherein the at least one sub-configuration included in the sub-configurations is configured with a codebook subset restriction parameter corresponding to a codebook type configuration, in case that the at least one sub-configuration is configured with an antenna port subset, that the codebook type configuration is set to ‘typeI-SinglePanel’, and that the report quantity configuration is set to ‘cri-RI-i1-CQI’.

4. The method of claim 1, further comprising:
receiving, from the base station, downlink control information (DCI) triggering at least one CSI report on PUSCH; and
in response to the DCI, determining a valid CSI report for the first CSI report in case that:
a first uplink symbol to carry the triggered at least one CSI report including an effect of a timing advance starts no earlier than a first predefined symbol, and
a second first uplink symbol to carry the first CSI report including an effect of a timing advance starts no earlier than a second predefined symbol,
wherein the second predefined symbol is defined as a next uplink symbol with its CP after end of a last symbol in time of a latest of: aperiodic CSI-RS resource for channel measurements, aperiodic CSI-IM used for interference measurements, and aperiodic NZP CSI-RS for interference measurement, and
wherein the aperiodic CSI-RS is used for channel measurement for the first CSI report.

5. The method of claim 1,
wherein a CSI computation delay parameter of the first CSI report corresponding to the CSI report configuration information including the list of sub-configurations is predefined.

6. A method performed by a base station in a wireless communication system, the method comprising:
transmitting, to a user equipment (UE), channel state information (CSI) report configuration information including a list of sub-configurations; and
receiving, from the UE, a first CSI report for at least one sub-configuration associated with the list of sub-configurations.

7. The method of claim 6, further comprising:
transmitting, to the UE, a report quantity configuration corresponding to the CSI report configuration,
wherein the first CSI report is determined based on the report quantity configuration, and
wherein the at least one sub-configuration included in the sub-configurations is configured with a codebook mode parameter, in case that the at least one sub-configuration is configured with an antenna port subset, that the at least one sub-configuration is configured with a port subset indicator, and that the CSI report configuration information includes sub-configurations of a mixed codebook type.

8. The method of claim 6, further comprising:
transmitting, to the UE, a report quantity configuration corresponding to the CSI report configuration,
wherein the first CSI report is determined based on the report quantity configuration, and
wherein at least one sub-configuration included in the sub-configurations is configured with a codebook subset restriction parameter corresponding to a codebook type configuration, in case that the at least one sub-configuration is configured with an antenna port subset, that the codebook type configuration is set to ‘typeI-SinglePanel’, and that the report quantity configuration is set to ‘cri-RI-i1-CQI’.

9. The method of claim 6, further comprising:
transmitting, to the UE, downlink control information (DCI) triggering at least one CSI report on PUSCH;
wherein a valid CSI report for the first CSI report is determined in response to the DCI, in case that:
a first uplink symbol to carry the triggered at least one CSI report including an effect of a timing advance starts no earlier than a first predefined symbol, and
a second first uplink symbol to carry the first CSI report including an effect of a timing advance starts no earlier than a second predefined symbol,
wherein the second predefined symbol is defined as a next uplink symbol with its CP after end of a last symbol in time of a latest of: aperiodic CSI-RS resource for channel measurements, aperiodic CSI-IM used for interference measurements, and aperiodic NZP CSI-RS for interference measurement, and
wherein the aperiodic CSI-RS is used for channel measurement for the first CSI report.

10. The method of claim 6,
wherein a CSI computation delay parameter of the first CSI report corresponding to the CSI report configuration information including the list of sub-configurations is predefined.

11. A user equipment (UE) in a wireless communication system, the UE comprising:
a transceiver; and
at least one processor coupled to the transceiver and configured to:
receive, from a base station, channel state information (CSI) report configuration information including a list of sub-configurations,
transmit, to the base station, a first CSI report for at least one sub-configuration associated with the list of sub-configurations.

12. The UE of claim 11, wherein the at least one processor is further configured to:
receive, from the base station, a report quantity configuration corresponding to the CSI report configuration, and
wherein the first CSI report is determined based on the report quantity configuration, and
wherein at least one sub-configuration included in the sub-configurations is configured with a codebook mode parameter, in case that the at least one sub-configuration is configured with an antenna port subset, that the at least one sub-configuration is configured with a port subset indicator, and that the CSI report configuration information includes sub-configurations of a mixed codebook type.

13. The UE of claim 11, wherein the at least one processor is further configured to:
receive, from the base station, a report quantity configuration corresponding to the CSI report configuration,
wherein the first CSI report is determined based on the report quantity configuration, and
wherein at least one sub-configuration included in the sub-configurations is configured with a codebook subset restriction parameter corresponding to a codebook type configuration, in case that the at least one sub-configuration is configured with an antenna port subset, that the codebook type configuration is set to ‘typeI-SinglePanel’, and that the report quantity configuration is set to ‘cri-RI-i1-CQI’.

14. The UE of claim 11, wherein the at least one processor is further configured to:
receive, from the base station, downlink control information (DCI) triggering at least one CSI report on PUSCH,
in response to the DCI, determining a valid CSI report for the first CSI report in case that:
a first uplink symbol to carry the triggered at least one CSI report including an effect of a timing advance starts no earlier than a first predefined symbol, and
a second first uplink symbol to carry the first CSI report including an effect of a timing advance starts no earlier than a second predefined symbol,
wherein the second predefined symbol is defined as a next uplink symbol with its CP after end of a last symbol in time of a latest of: aperiodic CSI-RS resource for channel measurements, aperiodic CSI-IM used for interference measurements, and aperiodic NZP CSI-RS for interference measurement, and
wherein the aperiodic CSI-RS is used for channel measurement for the first CSI report.

15. The UE of claim 11,
wherein a CSI computation delay parameter of the first CSI report corresponding to the CSI report configuration information including the list of sub-configurations is predefined.

16. A base station in a wireless communication system, the base station comprising:
a transceiver; and
at least one processor coupled to the transceiver and configured to:
transmit, to a user equipment (UE), channel state information (CSI) report configuration information including a list of sub-configurations, and
receive, from the UE, a first CSI report based on a second sub-configuration, wherein the second sub-configuration includes at least one of the sub-configurations.

17. The base station of claim 16, wherein the at least one processor is further configured to:
transmit, to the UE, a report quantity configuration corresponding to the CSI report configuration,
wherein the first CSI report is determined based on the report quantity configuration, and
wherein at least one sub-configuration included in the sub-configurations is configured with a codebook mode parameter, in case that the at least one sub-configuration is configured with an antenna port subset, that the at least one sub-configuration is configured with a port subset indicator, and that the CSI report configuration information includes sub-configurations of a mixed codebook type.

18. The base station of claim 16, wherein the at least one processor is further configured to:
transmit, to the UE, a report quantity configuration corresponding to the CSI report configuration,
wherein the first CSI report is determined based on the report quantity configuration, and
wherein at least one sub-configuration included in the sub-configurations is configured with a codebook subset restriction parameter corresponding to a codebook type configuration, in case that the at least one sub-configuration is configured with an antenna port subset, that the codebook type configuration is set to ‘typeI-SinglePanel’, and that the report quantity configuration is set to ‘cri-RI-i1-CQI’.

19. The base station of claim 16, wherein the at least one processor is further configured to:
transmit, to the UE, downlink control information (DCI) triggering at least one CSI report on PUSCH,
wherein a valid CSI report for the first CSI report is determined in response to the DCI, in case that:
a first uplink symbol to carry the triggered at least one CSI report including an effect of a timing advance starts no earlier than a first predefined symbol, and
a second first uplink symbol to carry the first CSI report including an effect of a timing advance starts no earlier than a second predefined symbol,
wherein the second predefined symbol is defined as a next uplink symbol with its CP after end of a last symbol in time of a latest of: aperiodic CSI-RS resource for channel measurements, aperiodic CSI-IM used for interference measurements, and aperiodic NZP CSI-RS for interference measurement, and
wherein the aperiodic CSI-RS is used for channel measurement for the first CSI report.

20. The base station of claim 16,
wherein a CSI computation delay parameter of the first CSI report corresponding to the CSI report configuration information including the list of sub-configurations is predefined.
